(19) United States
(12) Patent Application Publication
(10) Pub. No.: US 2016/0044227 A1
(43) Pub. Date: Feb. 11, 2016

(54) IMAGE CAPTURING DEVICE SUPPORT WITH REMOTE CONTROLLER

(71) Applicants: Ashley Lynn Johnson, Santa Rosa Beach, FL (US); Paul N. Marr, Miramar Beach, FL (US); Patrick C. Kullmann, Bloomington, MN (US); Steven Jester, Eden Prairie, MN (US)

(72) Inventors: Ashley Lynn Johnson, Santa Rosa Beach, FL (US); Paul N. Marr, Miramar Beach, FL (US); Patrick C. Kullmann, Bloomington, MN (US); Steven Jester, Eden Prairie, MN (US)

(21) Appl. No.: 14/657,710

(22) Filed: Mar. 13, 2015

Related U.S. Application Data
(60) Provisional application No. 62/115,634, filed on Feb. 12, 2015.
(60) Provisional application No. 62/000,347, filed on May 19, 2014.
(60) Provisional application No. 61/953,055, filed on Mar. 14, 2014.

(51) Int. Cl. H04N 5/232; H04B 1/3888; H04N 5/225; H04W 4/00; G03B 17/56; H04N 1/00

(52) U.S. Cl. CPC H04N 5/23206; G03B 17/561; H04N 1/00307; H04N 5/2256; H04W 4/008; H04B 1/3888

(57) ABSTRACT

A system for supporting an image capturing device includes a supporting device supporting the image capturing device, an extension device connected to the supporting device and extendable to a desired length, a lighting device mounted to the supporting device, and a control device controlling the image capturing device. In certain examples, the system includes a supporting device supporting a detachable case of the image capturing device, an extension device connected to the supporting device and extendable to a desired length. The case includes a lighting device to illuminate a user when taking a photograph using the image capturing device. The system further includes a control device controlling the lighting device of the case. In certain examples, the extension device is directly coupled to the case.

### CROSS-REFERENCE TO RELATED APPLICATIONS

This application claims priority to U.S. Patent Application Ser. No. 61/953,055 titled Handheld Monopod for Mobile Devices filed Mar. 14, 2014, U.S. Patent Application Ser. No. 62/000,347 titled Image Capturing Device Support with Remote Controller filed May 19, 2014, and U.S. Patent Application Ser. No. 62/115,634 titled Image Capturing Device Support with Remote Controller filed Feb. 12, 2015, the disclosures of which are hereby incorporated by reference in their entireties.

### BACKGROUND

A “selfie” photograph is an image of oneself resulting from holding a mobile device such as a smartphone at an arm's length away from the body and facing it towards oneself to capture a picture. A selfie is often captured using a smartphone, although other digital or film cameras can also be used. Because the mobile device must be held in the photographer's hand in order for the photographer to depress a capture button, the selfie is typically very close up and taken at an unusual angle. It can also be difficult to capture multiple people in a selfie photograph.

### SUMMARY

In general terms, this disclosure is directed to a system for supporting an image capturing device. In one possible configuration and by non-limiting example, the system includes a supporting device for supporting the image capturing device, a lighting device for providing artificial light, and a control device for controlling the image capturing device and/or the lighting device. Various aspects are described in this disclosure, which include, but are not limited to, the following aspects.

One aspect is a system for supporting an image capturing device, the system comprising: a supporting device configured to detachably support the image capturing device; an extension device connected the supporting device and extendable to a desired length; a lighting device mounted to the supporting device and configured to provide one or more light sources when capturing a photograph by the image capturing device; and a control device configured to control the image capturing device via a data communication network.

Another aspect is a method of capturing a photograph, the method comprising: mounting an image capturing device to a support device; attaching a lighting device to the support device; extending an extension device to a desired length, the extension device having forward and rearward ends and connected to the support device at the forward end; holding the rearward end of the extension device to capture a desired photograph; and interacting with a control device to transmit a user input to the image capturing device via a data transmission network, the user input configured to perform one or more functions of the image capturing device.

Yet another aspect is a hand-held apparatus for capturing a self-portrait photograph with a mobile device, the mobile device including a camera module, the apparatus comprising: a supporting device configured to detachably support the mobile device; a handling device configured for providing a grip; an extension device connecting the supporting device to the handling device, the extension device extendable to a desired length; a lighting device mounted to the supporting device and having one or more light emitting elements configured to produce artificial light when capturing the photograph; and a control device configured to remotely control the mobile device via a data communication network.

In general terms, this disclosure is further directed to a system for supporting an image capturing device, wherein the image capture device is at least partially covered by a case. In one possible configuration and by non-limiting example, the system includes an extension device coupled to the case of the image capturing device via a coupling device, the case including a lighting device for providing artificial light. The system further includes a control device for controlling the image capturing device and/or the lighting device. Various aspects are described in this disclosure, which include, but are not limited to, the following aspects.

One aspect is a system for supporting an image capturing device. The system includes a case for at least partially covering the image capturing device, the case including a lighting device configured to provide one or more light sources when capturing a photograph by the image capturing device; an extension device extendable to a desired length; a coupling device configured to connect the extension device to the case; and a control device configured to control the lighting device. In certain examples, the system further includes a supporting device configured to detachably support the case, and the coupling device is configured to couple the supporting device and the extension device.

Another aspect is a smartphone case comprising: a body; a plurality of light sources coupled to the body; and a fastening element connected to the body, wherein the fastening element is configured for attachment to an extension handle.

### BRIEF DESCRIPTION OF THE DRAWINGS

FIG. 1 is a schematic, perspective view of an example system for remotely controlling an image capturing device.

FIG. 2 is a schematic diagram illustrating the system 100 of FIG. 1.

FIG. 3 illustrates an exemplary architecture of a computing device that can be used to implement aspects of the present disclosure.

FIG. 4 illustrates an example network communication system of the system of FIG. 1.

FIG. 5 illustrates an example mobile application.

FIG. 6 illustrates an example control device.

FIG. 7 is a perspective view of an example system for remotely controlling an image capturing device.

FIG. 8 is an expanded view of the system of FIG. 7 illustrating an example supporting device.

FIG. 9 is a side view of the system of FIG. 8.

FIG. 10 is a front view of the system with the supporting device of FIG. 8.

FIG. 11 is a top view of the supporting device of FIG. 8.

FIG. 12 is a perspective view of the supporting device of FIG. 8 illustrating the supporting device supporting the image capturing device.

FIG. 13 illustrates an example extension device.

FIG. 14 illustrates an example coupling device and an example lighting device.

FIG. 15 is a perspective view of an example control device.

FIG. 16 is a top view of the control device of FIG. 15 illustrating example input devices.

FIG. 17 is a bottom view of the control device of FIG. 15.

FIG. 18 is a perspective view of another example system for remotely controlling an image capturing device.

FIG. 19 is an expanded view of the system of FIG. 18.

FIG. 20 is a perspective view of an example supporting device.

FIG. 21 is a front perspective view of the system in the storage condition.

FIG. 22 is a rear perspective view of the system in the storage condition.

FIG. 23 is a perspective view of the system used as a stand for the image capturing device.

FIG. 24 is a perspective view of the system used as a stand with a lighting element used separately.

FIG. 25 is an example control device.

FIG. 26 is a perspective view of the system of FIG. 18 illustrating that a lighting device is in operation.

FIG. 27 is a perspective view of the system used as the stand, as shown in FIG. 24, illustrating that the lighting device is in operation.

FIG. 28 is a schematic diagram illustrating another example system for remotely controlling the image capturing device and/or a lighting device.

FIG. 29 is a schematic diagram illustrating yet another example system for remotely controlling the image capturing device and/or a lighting device.

FIG. 30 schematically illustrates a part of an example coupling device of FIG. 29 that is included in a structure of a case.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

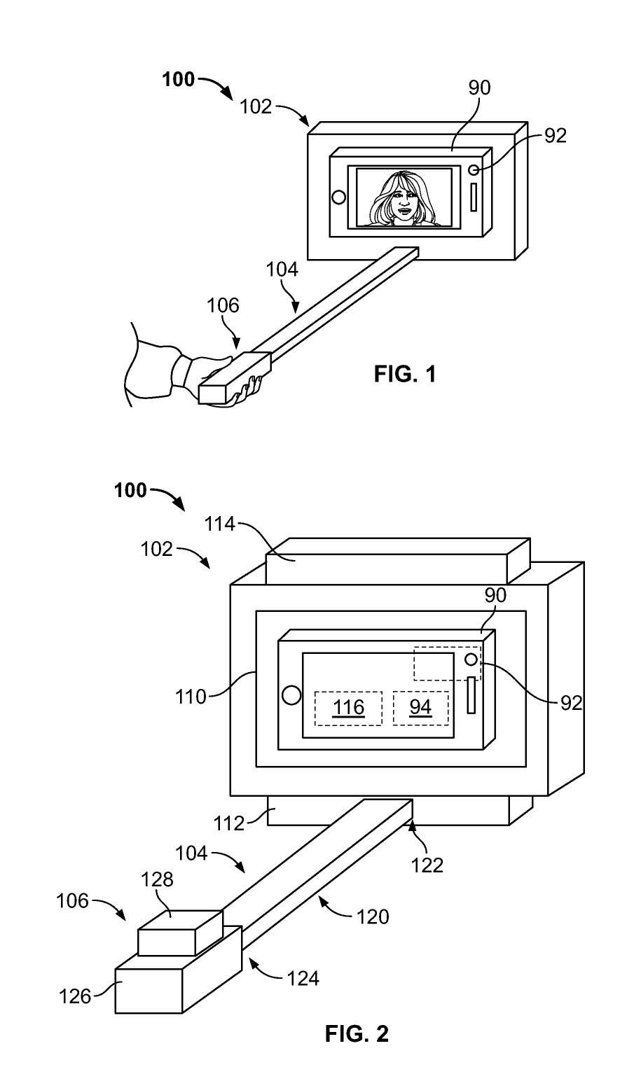

FIG. 1 is a schematic, perspective view of an example system 100 for remotely controlling an image capturing device 90. In some embodiments, the system 100 includes an image capturing module 102, an extension module 104, and a handling module 106.

The system 100 operates to permit a user to capture photographs remotely from the image capturing device 90. Such photographs include, for example, any types of still images (such as pictures) and moving images (such as videos and movies). In some embodiments, the system 100 is configured for the user to remotely operate the image capturing device 90 that is not at an arm's length from the user. For example, the system 100 is used to capture a self-portrait photograph or video, which is also known as a “selfie.” The system 100 allows the user to place the image capturing device 90 at a distance further than the arm's length from the user and to take a self-portrait photograph by remotely controlling the image capturing device 90.

The user can use the system 100 to create a longer distance between the user and the image capturing module 102 and ensure to capture a proper photograph as a result. To facilitate this image capturing process, the system 100 further includes a lighting device having one or more light emitting elements configured to create proper lighting as necessary.

The system 100 can also be used to capture group photographs. Yet another application of the system 100 is video-recording of sport events, such as skateboarding, bicycling, and rollerblading, where a camera man needs a closer perspective to fully capture the events.

The image capturing device 90 is a device operable to capture photographs. Examples of the image capturing device 90 include hand-held cameras (either digital or analog) and mobile computing devices incorporating camera modules. The mobile computing devices include, for example, a smart phone, a tablet computer (e.g., an iPad® mobile digital device), an iPod® mobile digital device, or other similar mobile devices. The image capturing device 90 includes a camera module 92 configured to capture and record photographs therethrough, and a photograph management application 94 configured to manage photographs captured by the camera module 92 and/or stored in the image capturing device 90. In some embodiments, the photograph management application 94 is a system, application program and/or software module that run on the image capturing device 90 and are configured to manage the images or photographs stored in the image capturing device 90. The photograph management application is referred to as, for example, an album, gallery, photo book or photo library. In some embodiments the image capturing device 90 is at least partially covered by a case when the image capturing device 90 is used with the system 100. In other embodiments, the image capturing device 90 is not covered with a case when used with the system 100. A case for the image capturing device 90 is configured to at least partially cover or wrap the image capturing device 90 for various purposes, such as protection of the image capturing device 90 or ornamental purposes. The case can be made of various materials, such as plastic (either hard or flexible), rubber, leather, metal, or other materials or combinations of these or other materials. The case for the image capturing device 90 can be of various types, such as frames, pouches, sleeves, holsters, shells, skins, bumpers, flip cases, wallets, screen protector, and other types suitable to at least partially cover the image capturing device 90.

The image capturing module 102 is configured to support the image capturing device 90 (either with or without a case) and engage the extension module 104.

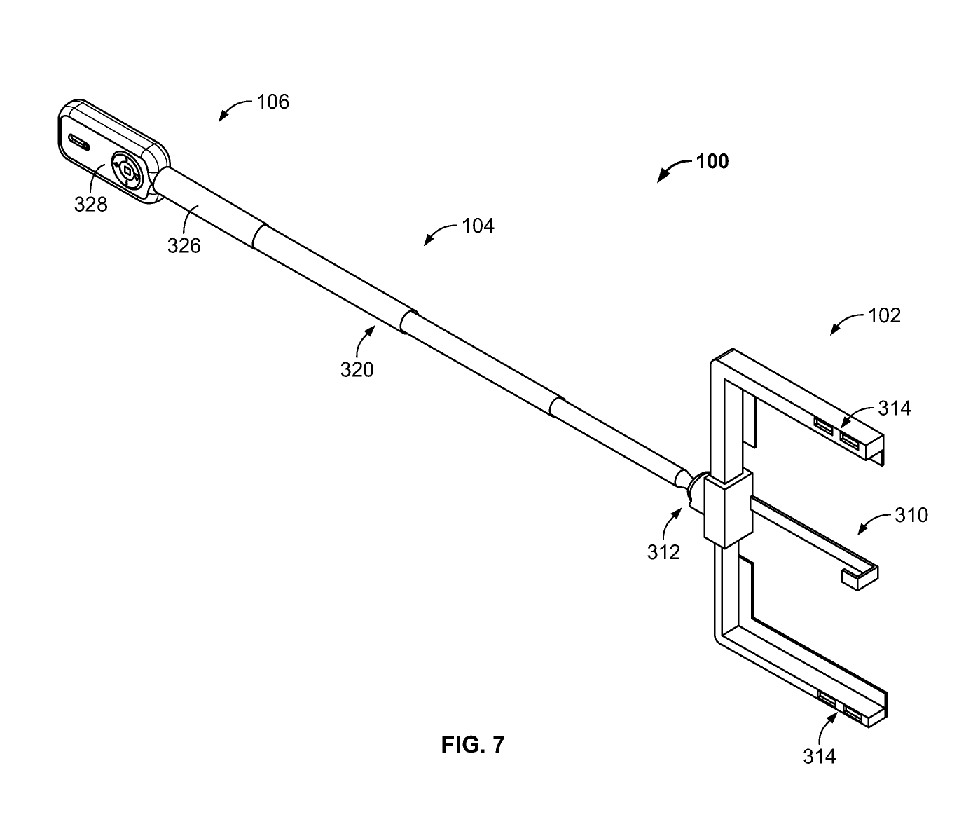

In some embodiments, the image capturing module 102 can provide light sources to illuminate the user when the user operates the image capturing device 90 to take a picture while holding it with the extension module 104 and the handling module 106. Such embodiments are illustrated and described in more detail with reference to FIGS. 7-27.

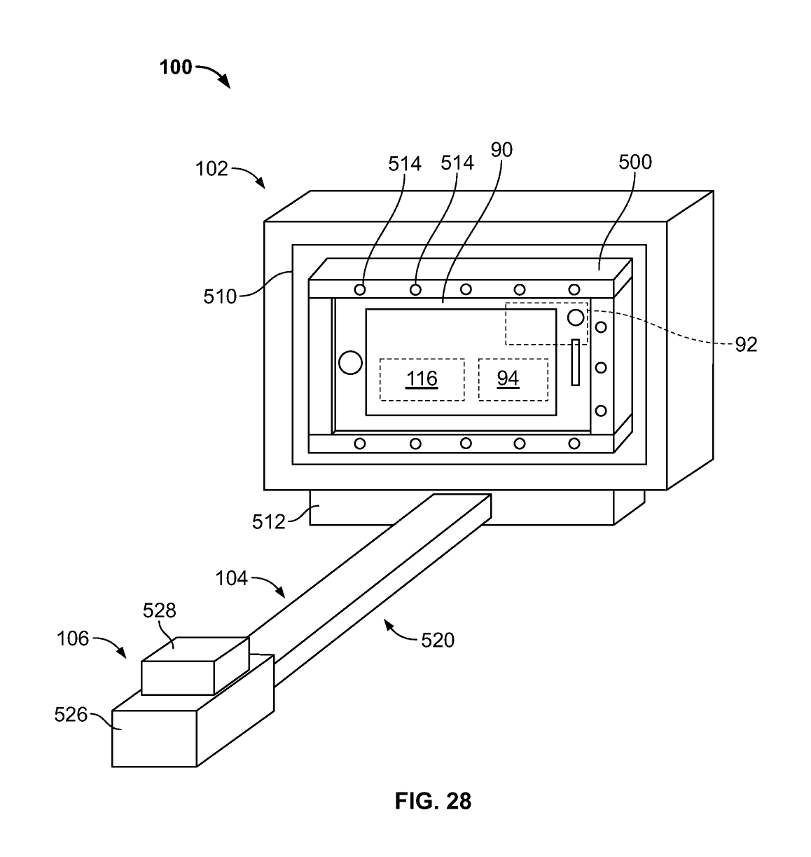

In other embodiments, the image capturing module 102 is configured to hold a case (such as a case 500, 600 (FIGS. 28-30)) for the image capturing device 90 when the case incorporates its own lighting elements for illuminating a user. These embodiments are illustrated and described with reference to FIG. 28.

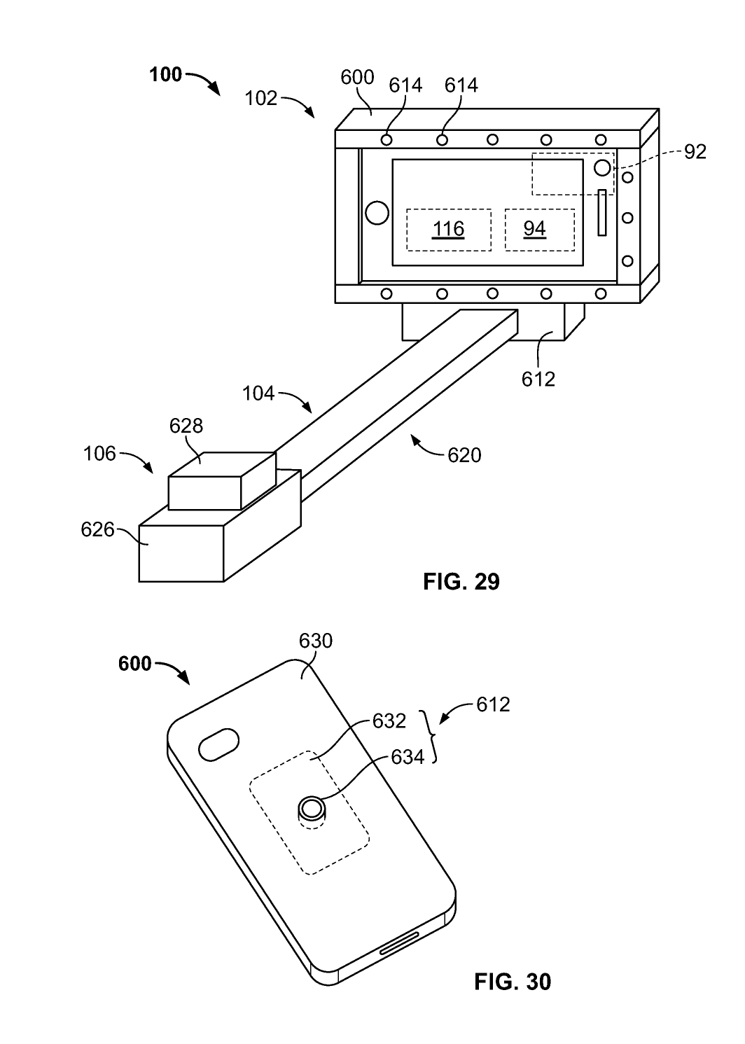

In yet other embodiments, the image capturing module 102 is configured as a case (such as the case 500, 600) for the image capturing device 90, and the case includes lighting sources for illuminating a user. These embodiments are illustrated and described with reference to FIG. 29.

The extension module 104 is configured to connect the image capturing module 102 to the handling module 106.

The handling module 106 operates to provide a grip for a user to hold the system 100. Further, the handling module 106 permits the user to control the image capturing module 102.

FIG. 2 is a schematic diagram illustrating the system 100 of FIG. 1. The image capturing module 102 includes a supporting device 110, a coupling device 112, and a lighting device 114. In some embodiments, the image capturing module 102 further includes a mobile application 116. The extension module 104 includes an extension device 120. The handling module 106 includes a handling device 126 and a control device 128.

The supporting device 110 is configured to support the image capturing device 90. In some embodiments, the supporting device 110 operates to detachably engage the image capturing device 90. The supporting device 110 is configured to be adjustable to support different image capturing devices 90 with different dimensions. In some embodiments, the supporting device 110 is also configured to detachably engage the image capturing device 90 with a case thereon.

The coupling device 112 operates to couple the supporting device 110 to the extension module 104. In some embodiments, the coupling device 112 is configured to detachably engage the supporting device 110 to the extension module 104.

The lighting device 114 is configured to provide one or more light sources when capturing one or more photographs by the image capturing device 90. The lighting device 114 is configured to be attached to the supporting device 110. In some embodiments, the lighting device 114 is detachably mounted the supporting device 110. For example, the lighting device 114 can be detached from the supporting device 110 and located apart from the supporting device 110 that holds the image capturing device 90.

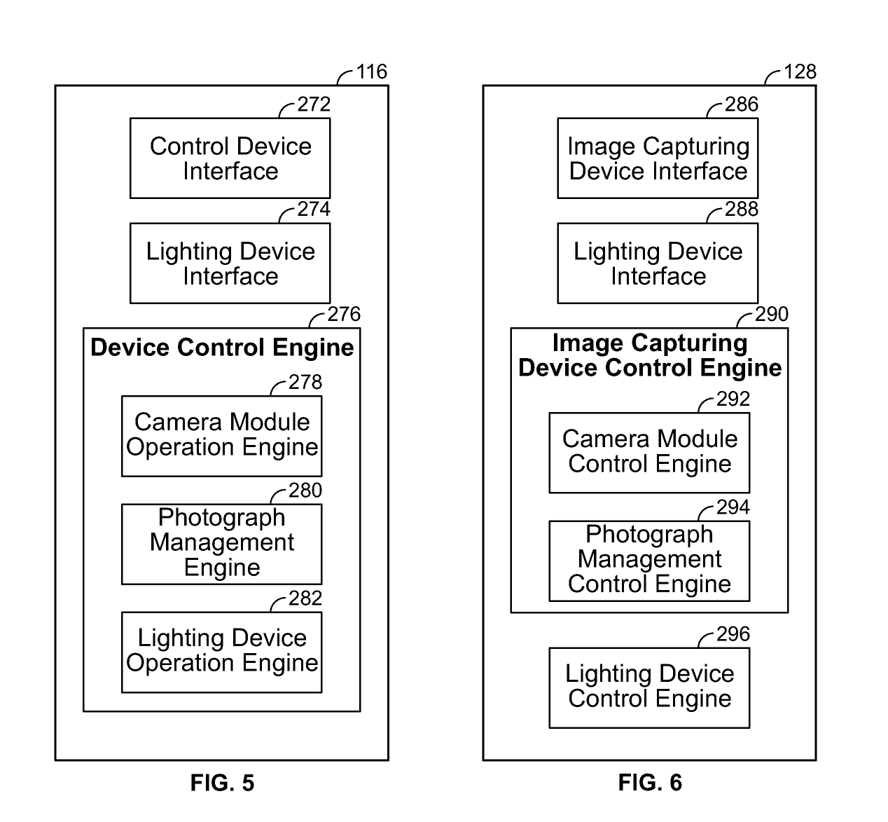

The mobile application 116 is configured to provide an interface between the image capturing device 90 and the control device 128. The mobile application 116 is application software designed to run on the image capturing device 90. The mobile application 116 is executed within the image capturing device 90 and operates to receive input from the control device 128 to control the image capturing device 90. In some embodiments, the mobile application 116 operates to communicate with the control device 128 to control the lighting device 114 as well as the image capturing device 90. In other embodiments, as described below, the image capturing module 102 does not need the mobile application 116, and the control device 128 operates to communicate directly with the image capturing device 90 and/or the lighting device 114. An example of the mobile application 116 is illustrated and described in more detail with reference to FIG. 5.

The extension device 120 operates to connect the coupling device 112 to the handling device 126. The extension device 120 has a forward end 122 and a rearward end 124. The extension device 120 is connected to the coupling device 112 at the forward end 122 and connected to the handling device 126 at the rearward end 124. In some embodiments, the extension device 120 is adjustable to extend to a desired length between the image capturing module 102 and the handling device 126. The extension device 120 is collapsible to a predetermined length for compact storage.

The handling device 126 provides a grip for the user to hold the system 100. The handling device 126 is connected to the extension device 120 at the rearward end 124 thereof. In some embodiments, the handling device 126 is configured as part of the extension device 120 at the rearward end 124.

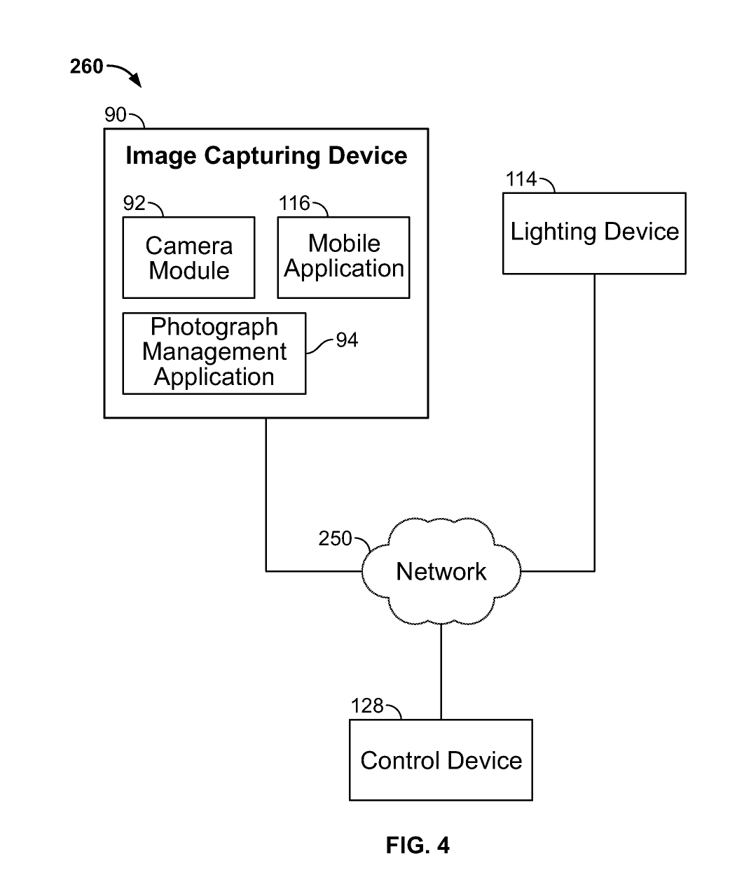

The control device 128 operates to control the image capturing module 102. In some embodiments, the control device 128 is configured to control the image capturing 90. For example, the control device 128 controls the camera module 92 and/or the photograph management application 94 that runs on the image capturing device 90. In other embodiments, the control device 128 is also configured to directly communicate with, and control, the lighting device 114. The control device 128 can communicate with the image capturing device 90 and/or the lighting device 114 via either wired or wireless network 250 (FIG. 4). In some embodiments, as described above, the control device 128 communicates with the image capturing device 90 and/or the lighting device 114 through the mobile application 116.

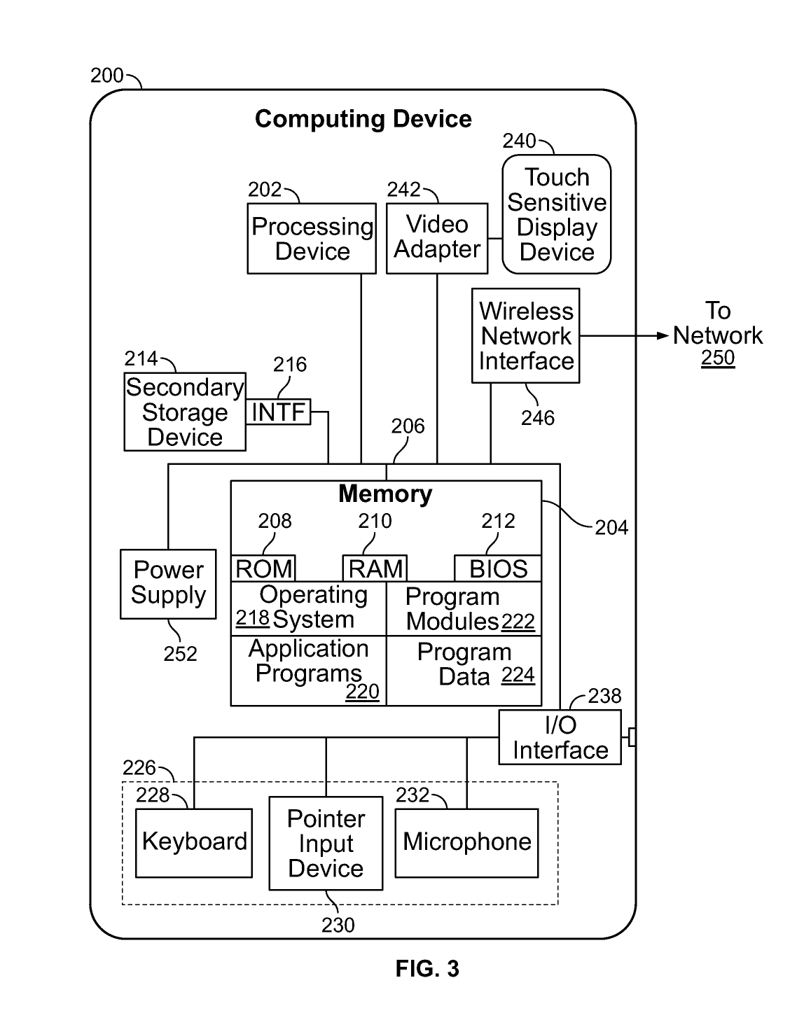

FIG. 3 illustrates an exemplary architecture of a computing device that can be used to implement aspects of the present disclosure, including the image capturing device 90 or the control device 128, and will be referred to herein as the computing device 200. The computing device 200 is used to execute the operating system, application programs, and software modules (including the software engines) described herein.

The computing device 200 includes, in some embodiments, at least one processing device 202, such as a central processing unit (CPU). A variety of processing devices are available from a variety of manufacturers, for example, Intel or Advanced Micro Devices. In this example, the computing device 200 also includes a system memory 204, and a system bus 206 that couples various system components including the system memory 204 to the processing device 202. The system bus 206 is one of any number of types of bus structures including a memory bus, or memory controller; a peripheral bus; and a local bus using any of a variety of bus architectures.

Examples of computing devices suitable for the computing device 200 include a desktop computer, a laptop computer, a tablet computer, a mobile device (such as a smart phone, an iPod® mobile digital device, or other mobile devices), or other devices configured to process digital instructions.

The system memory 204 includes read only memory 208 and random access memory 210. A basic input/output system 212 containing the basic routines that act to transfer information within the computing device 200, such as during start up, is typically stored in the read only memory 208.

The computing device 200 also includes a secondary storage device 214 in some embodiments, such as a hard disk drive, for storing digital data. The secondary storage device 214 is connected to the system bus 206 by a secondary storage interface 216. The secondary storage devices and their associated computer readable media provide nonvolatile storage of computer readable instructions (including application programs and program modules), data structures, and other data for the computing device 200.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 214 or memory 204, including an operating system 218, one or more application programs 220, other program modules 222, and program data 224.

In some embodiments, the computing device 200 includes input devices to enable a user to provide inputs to the computing device 200. Examples of input devices 226 include a keyboard 228, pointer input device 230, microphone 232, and touch sensitive display 240. Other embodiments include other input devices 226. The input devices are often connected to the processing device 202 through an input/output interface 238 that is coupled to the system bus 206. These input devices 226 can be connected by any number of input/output interfaces, such as a parallel port, serial port, game port, or a universal serial bus. Wireless communication between input devices and interface 238 is possible as well, and includes infrared, BLUETOOTH® wireless technology, 802.11a/b/g/n, cellular, or other radio frequency communication systems in some possible embodiments.

In this example embodiment, a touch sensitive display device 240 is also connected to the system bus 206 via an interface, such as a video adapter 242. The touch sensitive display device 240 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 240, the computing device 200 can include various other peripheral devices (not shown), such as speakers or a printer.

When used in a local area networking environment or a wide area networking environment (such as the Internet), the computing device 200 is typically connected to the network 250 through a network interface, such as a wireless network interface 246. Other possible embodiments use other communication devices. For example, some embodiments of the computing device 200 include an Ethernet network interface, or a modem for communicating across the network.

In some examples, the computing device 200 includes a power supply 252 that provides electric power to several components and elements of the computing device 200. Examples of the power supply 252 include AC power supplies, DC power supplies, and batteries, either disposable or rechargeable.

The computing device 200 typically includes at least some form of computer-readable media. Computer readable media includes any available media that can be accessed by the computing device 200. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

FIG. 4 illustrates an example network communication system 260 of the system 100. The network communication system 260 includes the image capturing device 90 including the camera module 92 and the photograph management application 94, and the lighting device 114, the control device 128, and the data communication network 250. As described above, in some embodiments, the image capturing device 90 includes the mobile application 116.

The network 250 communicates digital data between one or more computing devices, such as between the image capturing device 90 and the control device 128 and/or between the lighting device 114 and the control device 128. Examples of the network 516 include a local area network and a wide area network, such as the Internet.

In some embodiments, the network 516 includes a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or RF signals, and an optical or RF receiver for receiving optical or RF signals. Examples of wireless communication systems among the image capturing device 90, the lighting device 114, and the control device 128 include infrared, BLUETOOTH® wireless technology, Wi-Fi communication devices (such as utilizing wireless routers or wireless access points) (e.g., 802.11a/b/g/n), cellular communication devices (such as utilizing one or more cellular base stations), and other radio frequency communication systems in some possible embodiments.

FIG. 5 illustrates an example mobile application 116. In some embodiments, the mobile application 116 includes a control device interface 272, a lighting device interface 274, and a device control engine 276. In some embodiments, the device control engine 276 includes a camera module operation engine 278, a photograph management engine 280, and a lighting device operation engine 282.

The control device interface 272 is configured to enable the image capturing device 90 to communicate with the control device 128. In some embodiments, the control device interface 272 is used to establish data communication between the image capturing device 90 and the control device 128 through the network 250, as described in FIG. 4.

The lighting device interface 274 is configured to enable the lighting device 114 to communicate with the image capturing device 90. In some embodiments, the lighting device interface 274 is used to establish data communication between the image capturing device 90 and the lighting device 114 through the network 250, as described in FIG. 4.

The device control engine 276 is configured to receive inputs from the control device 128 through the control device interface 272 and control the image capturing device 90 and/or the lighting device 114 based upon inputs from the control device 128.

The camera module operation engine 278 operates to cause the camera module 92 to perform several functions based upon input from the control device 128. Examples of the functions of the camera module 92 is photograph shooting (i.e., taking of a photograph), selection of different shooting modes, adjustment of shutter speed, adjustment of exposure, selection of flash types, selection of focus modes, adjustment of aperture sizes, selection of zoom features, selection of filter effects, selection of other photographic effects, switch between multiple cameras (e.g., front and rear cameras), and selection of other camera settings.

The photograph management engine 280 operates to perform several functions of the photograph management application 94 based upon input from the control device 128. Examples of the functions of the photograph management application 94 include review, preview, deletion and transfer of photographs stored in the image capturing device 90.

The lighting device operation engine 282 operates to perform several functions of the lighting device 114 based upon input from the control device 128. Examples of the functions of the lighting device 114 include adjustment of duration, brightness, and timing of lighting sources, and selection of flash modes.

FIG. 6 illustrates an example control device 128. In some embodiments, the control device 128 includes an image capturing device interface 286, a lighting device interface 288, an image capturing device control engine 290 including a camera module control engine 292 and a photograph management control engine 294, and a lighting device control engine 296.

The image capturing device interface 286 is configured to enable the control device 128 to communicate with the image capturing device 90. In some embodiments, the image capturing device interface 286 can communicate with the control device interface 272 of the mobile application 116. In other embodiments, the control device 128 is connected directly to the image capturing device 90 through the image capturing device interface 286 and a communication interface of the image capturing device 90. In some embodiments, the image capturing device interface 286 is used to establish data communication between the image capturing device 90 and the control device 128 through the network 250, as described in FIG. 4.

The lighting device interface 288 is configured to enable the lighting device 114 to communicate with the control device 128. In some embodiments, the lighting device interface 288 is used to establish data communication between the control device 128 and the lighting device 114 through the network 250, as described in FIG. 4.

The image capturing device control engine 290 operates to receive input from a user for operating the image capturing device 90 and/or the lighting device 114, and transmit the input to the image capturing device 90 and/or the lighting device 114 through the image capturing device interface 286 and the lighting device interface 288, respectively.

As described above, in some embodiments, the image capturing device control engine 290 includes the camera module control engine 292 and the photograph management control engine 294.

The camera module control engine 292 operates to receive input from the user for operating the camera module 92 and transmit the input to the camera module 92 through the image capturing device interface 286. The input from the user is configured to cause the camera module 92 to perform several functions, as described above.

The photograph management control engine 294 operates to receive input from the user for operating the functions of the photograph management application 94 of the image capturing device 90, and transmit the input to the photograph management application 94 through the image capturing device interface 286. The input from the user is configured to cause the photograph management application 94 to perform several functions, as described above.

The lighting device control engine 296 operates to receive input from the user for operating the functions of the lighting device 144, and transmit the user input to the lighting device 114. The input from the user is configured to cause the lighting device 114 to perform several functions, as described above.

A first embodiment of the system 100 is described and illustrated with reference to FIGS. 7-17. As the concepts and features of the system 100, as described in FIGS. 1-6 are applied to the first embodiment, the description for the system 100 shown in FIGS. 1-6 is hereby incorporated by reference for the first embodiment. Where like or similar features or elements are shown, the same or similar reference numbers will be used where possible.

FIG. 7 is a perspective view of an example system 100 for remotely controlling an image capturing device 90. As describe above, the system 100 includes the image capturing module 102, the extension module 104, and the handling module 106.

In this embodiment, the system 100 operates as a portable handheld monopod for the image capturing device 90, such as a mobile device.

In this embodiment, the image capturing module 102 includes a supporting device 310, a coupling device 312, and a lighting device 314. In some embodiments, the image capturing module 102 further include the mobile application 116 as illustrated above. The extension module 104 includes an extension device 320. The handling module 106 includes a handling device 326 and a control device 328.

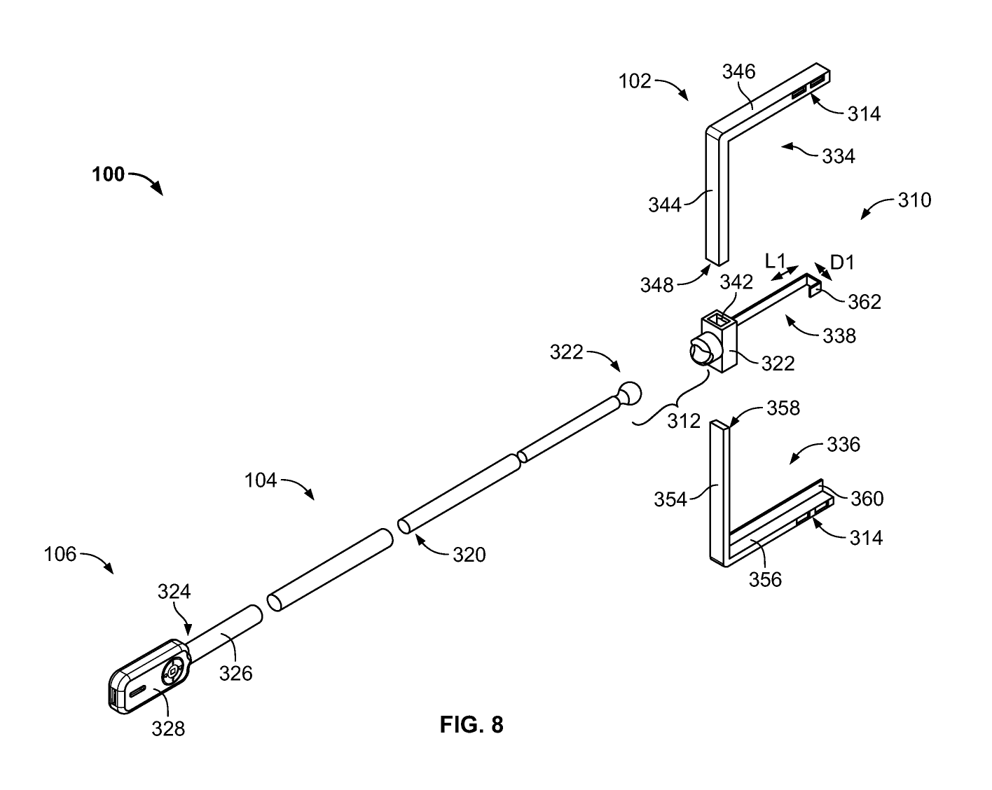

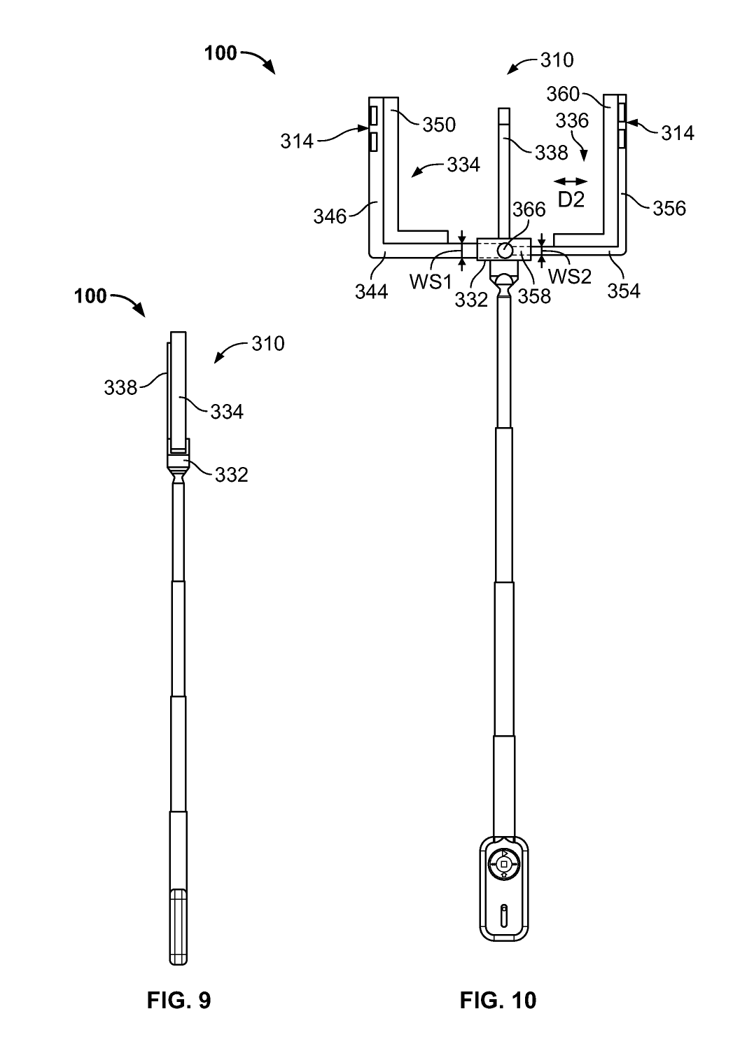

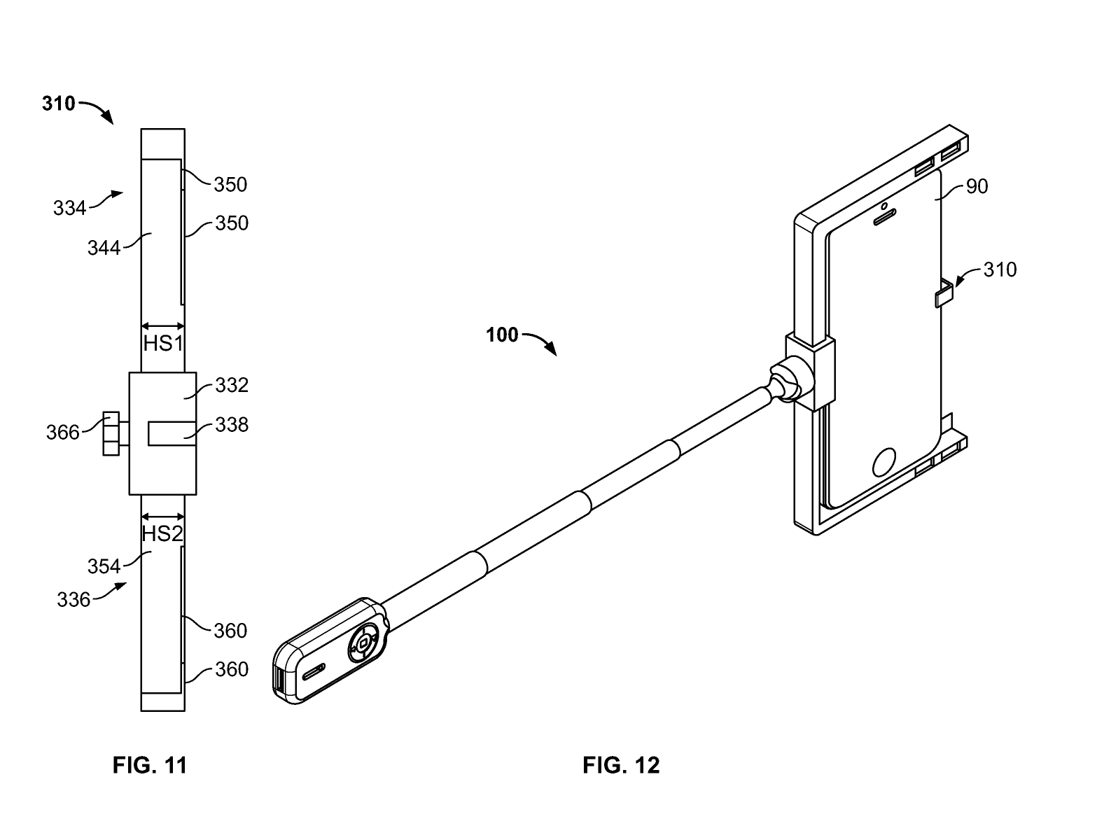

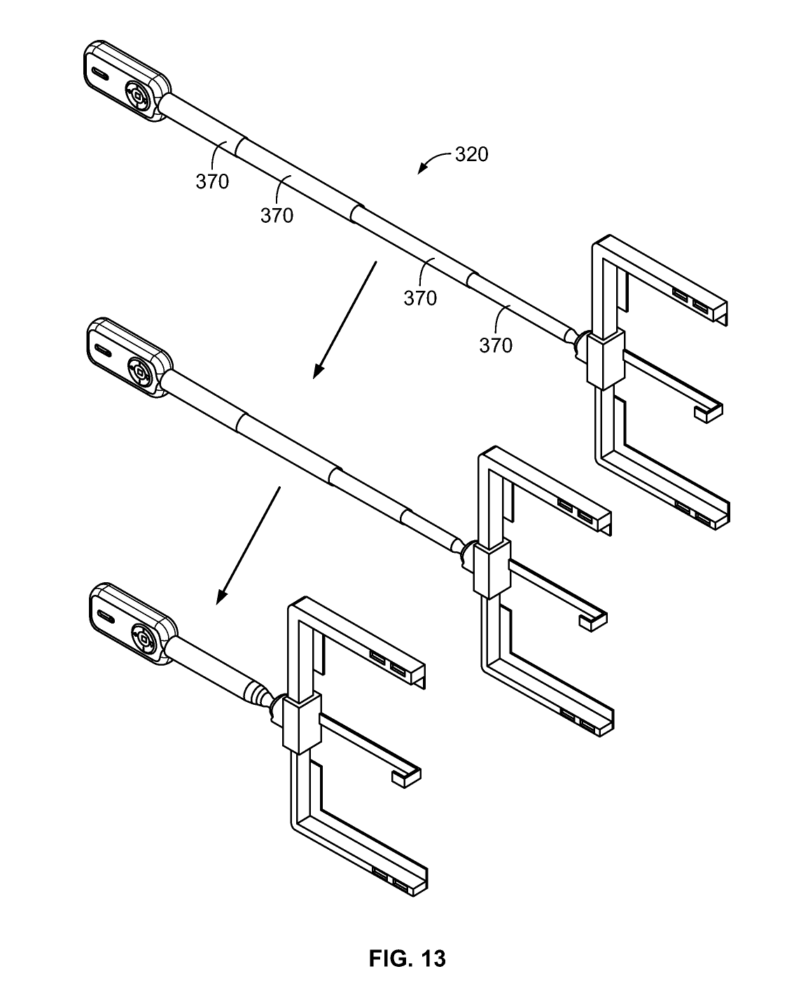

FIGS. 8-12 illustrate an example supporting device 310. In particular, FIG. 8 is an expanded view of the system 100 of FIG. 7, illustrating an example supporting device 310. FIG. 9 is a side view of the system 100 of FIG. 8. FIG. 10 is a front view of the system 100 with the supporting device 310 of FIG. 8. FIG. 11 is a top view of the supporting device 310 of FIG. 8. FIG. 12 is a perspective view of the supporting device 310 of FIG. 8, illustrating that the supporting device 310 supports the image capturing device 90.

The supporting device 310 includes a frame 332, a first side member 334, a second side member 336, and an intermediate member 338.

The supporting device 310 operates as a holster assembly configured to hold the image capturing device 90 in place. The supporting device 310 is connected to a forward end 322 of the extension device 320 and configured to be adjustable to support different image capturing device 90 with different dimensions. In the depicted example, the supporting device 310 incorporates the lighting device 314.

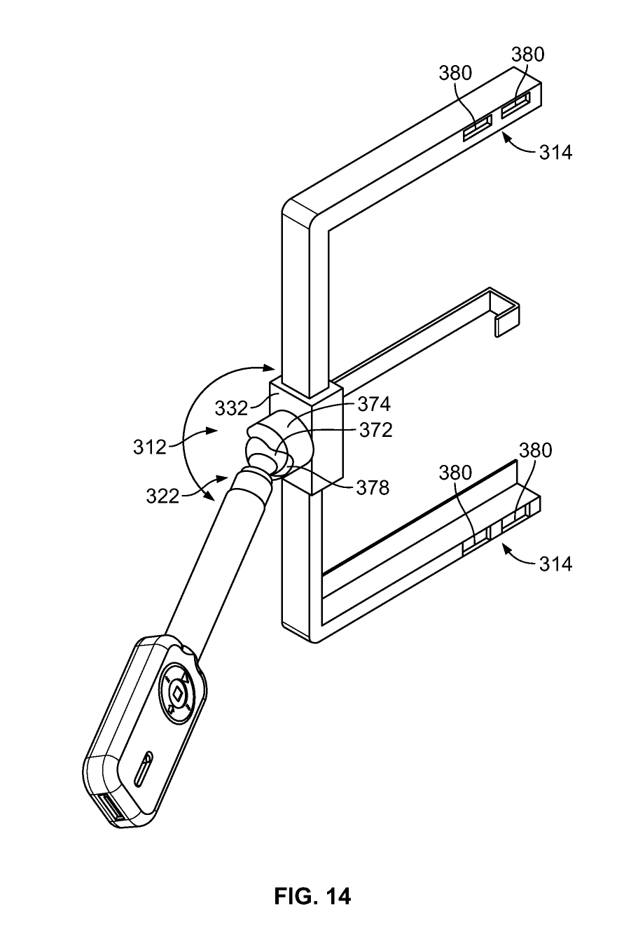

The frame 332 is configured to connect the first and second side members 334 and 336 and the intermediate member 338. Further, the frame 332 is constituted as part of the coupling device 312, as illustrated with reference to FIG. 14.

In some embodiments, the frame 332 includes a through-hole 342 through which either the first side member 334 or the second side member 336, or both, are inserted for coupling the first and second side members 334 and 336 thereto. In the depicted example, the frame 332 is shaped as a rectangular hollow body, which looks like a portion of an extruded rectangular member.

The first side member 334 is configured to support one end of the image capturing device 90 (FIG. 12). In some embodiments, the first side member 334 includes a first stem portion 344 and a first leg portion 346. The first stem portion 344 is configured to be connected to the frame 332. In some embodiments, the first stem portion 344 is inserted into the through-hole 342 of the frame 332 and engaged with the frame 332. The first leg portion 346 is configured to be engaged with the one end of the image capturing device 90. In some embodiments, the first leg portion 346 is connected to the first stem portion 344 so that the first stem portion 344 and the first leg portion 346 together form substantially an L-shape. In some embodiments, the first stem portion 344 are formed integrally with the first leg portion 346 and then bent about 90 degree relative to the first leg portion 346 to form the L-shape.

In some embodiments, at least a portion of the first stem portion 344 includes a hollow 348 configured to receive a portion of a second stem portion 354 of the second side member 336. An example feature and operation of the hollow 348 is described below in more detail.

In some embodiments, the first side member 334 incorporates the lighting device 314. In the depicted example, the lighting device 314 is attached to the first leg portion 346. In other embodiments, the lighting device 314 is mounted or embedded into the first stem portion 344 and/or the first leg portion 346.

In some embodiments, the first side member 334 includes a first lip extrusion 350 (FIG. 10) configured to hold up the image capturing device 90. An example of the first lip extrusion 350 is illustrated and described in more detail with reference to FIG. 10.

The second side member 336 is configured to support the other end of the image capturing device 90 (FIG. 12). In some embodiments, the second side member 336 includes a second stem portion 354 and a second leg portion 356. The second stem portion 354 is configured to be connected to the frame 332. In some embodiments, the second stem portion 354 is inserted into the through-hole 342 of the frame 332 and engaged with the frame 332. The second leg portion 356 is configured to be engaged with the other end of the image capturing device 90. In some embodiments, the second leg portion 356 is connected to the second stem portion 354 so that the second stem portion 354 and the second leg portion 356 together form substantially an L-shape. In some embodiments, the second stem portion 354 are formed integrally with the second leg portion 356 and then bent about 90 degree relative to the second leg portion 356 to form the L-shape.

In some embodiments, the second stem portion 354 is configured to be adjustably engaged with the first stem portion 344. For example, the second stem portion 354 have an insertion portion 358 configured to be inserted into, and engaged with, the hollow 348 of the first stem portion 344. In this configuration, the insertion portion 358 of the second stem portion 354 has a cross section marginally smaller than a cross section of the hollow 348 of the first stem portion 344 so that the insertion portion 358 fit into the hollow 348, thereby permitting the second stem portion 354 to move relative to the first stem portion 344. As such, a position of the second side member 336 is adjustable in a direction D2 (FIG. 10) relative to the first side member 334 that is fixed to the frame 223. For example, as shown in FIGS. 10 and 11, the first stem portion 344 has a width (W_{S1}) and a height (H_{S1}) that are marginally larger than a width (W_{S2}) and a height (H_{S2}) of the second stem portion 354. The relative position of the first and second side members 334 and 336 can be adjusted with a pairing mechanism 366, as illustrated below.

Similarly to the first side member 334, in some embodiments, the second side member 336 incorporates the lighting device 314. In the depicted example, the lighting device 314 is attached to the second leg portion 356. In other embodiments, the lighting device 314 is mounted or embedded into the second stem portion 354 and/or the second leg portion 356.

Similarly to the first side member 334, in some embodiments, the second side member 336 includes a second lip extrusion 360 (FIG. 10) configured to hold up the image capturing device 90. An example of the second lip extrusion 360 is illustrated and described in more detail with reference to FIG. 10.

The intermediate member 338 is configured to support a middle portion of the image capturing device 90 as illustrated in FIG. 12. The intermediate member 338 is connected to the frame 332 and extends therefrom. In some embodiments, the intermediate member 338 is configured to be adjustable in length (L1) and/or depth (D1) so that the supporting device 310 accommodates different image capturing devices 90 with different dimensions. In some embodiments, the intermediate member 338 includes a hook 362 configured to grab a portion of the image capturing device 90 as illustrated in FIG. 12.

In some embodiments, as shown in FIGS. 10 and 11, the supporting device 310 further includes a pairing mechanism 366 configured to set a position of the second side member 336 relative to the first side member 334. In the depicted example, the pairing mechanism 366 includes a peripheral screw configured to be screwed into the insertion portion 358 of the second stem portion 354 through the first stem portion 344 (also through the frame 332, in some embodiments) so that the screw tightens up the insertion portion 358 of the second stem portion 354 to the first stem portion 344.

In other embodiments, the pairing mechanism 366 is configured as a torsion spring fitted gear (not shown) that can be arranged in the frame 332. For example, the first side member 334 and the second side member 336 are paired through the torsion spring fitted gear located within the frame 332. The first side member 334 is configured to contain complementary gear groves located on the inner surface of a portion of the first side member that is inserted into the through-hole 342 of the frame 332. The second side member 336 is configured to contain complementary gear groves located on the outer surface of a portion (e.g., the insertion portion 358) of the second side member 336 that is inserted into the through-hole 342 of the frame 332. The first side member 334 is situated inside the through-hole 342 at one end of the gear, and the second side member 336 is situated inside the through-hole 342 at the other end of the gear, so that the gear teeth of the first and second side members 334 and 336 are engaged with the gear. Rotation of the gear applies a force on the gear teeth of the members 334 and 336 and moves the two members 334 and 336 relative to each other in opposite directions. The torsion spring engaged with the gear provides a torque for the spring which in turn provides a force on the members 334 and 336, downwards force for the first side member 334 and upwards force for the second side member 336. This configuration allows the user to increase the distance between the members 334 and 336 to fit in the image capturing device 90 between them and have the pairing mechanism automatically contract the distance and thus providing a snug fit for the image capturing device.

As depicted in FIGS. 10 and 11, the first lip extrusion 350 is configured to be horizontally extruded from an inner periphery of the first side member 334 so as to support the front or rear face (the larger surface) of the image capturing device 90 as shown in FIG. 12. The second lip extrusion 360 is also arranged in the second side member 336 in a similar manner to the first lip extrusion 350.

FIG. 13 illustrates an example extension device 320. In some embodiments, the extension device 320 is configured as a telescopic monopod or unipod. For example, the extension device 320 includes a plurality of telescopic poles 370. In the depicted example, the extension device 320 includes four telescopic poles 370.

The plurality of telescopic poles 370 are concentric tubular sections configured to slide into one another. As such, the extension device 320 is extendable to a desired length and collapsible to a shorter predetermined length. When collapsed, the extension device 320, as well as the entire system 100, becomes small enough to transport or carry.

The telescopic poles 370 can be made of any material that is light and sustainable. Examples of the material include plastic and aluminum.

FIG. 14 illustrates an example coupling device 312 and an example lighting device 314. In some embodiments, the coupling device 312 includes a ball portion 372 and a socket portion 374.

The coupling device 312 operates to couple the supporting device 310 to the extension device 320. In some embodiments, the coupling device 312 detachably couples the supporting device 310 to the extension device 320. In some embodiments, the coupling device 312 pivotally couples the supporting device 310 to the extension device 320 so that the supporting device 310 freely rotates about the extension device 320 with three degrees of freedom (e.g., pitching, yawing, and rolling). In the depicted example, the coupling device 312 is configured as a ball joint type.

The ball portion 372 is formed at the forward end 322 of the extension device 320 and configured to be rotatably inserted into the socket portion 374 of the coupling device 312.

The socket portion 374 is formed on the frame 332 of the supporting device 310 and configured to rotatably receive the ball portion 372 of the coupling device 312. In some embodiments, the ball portion 372 is inserted into the socket portion 374 in interference fit, such as press fit or shrink fit.

In some embodiments, the socket portion 374 includes semi-circular cutouts 378 on opposite sides of the socket portion 374 to improve the range of motion of the ball portion 372 relative to the socket portion 374.

In other embodiments, instead of the ball joint type coupling, other coupling mechanisms are used, such as hinges and screw/bolt arrangements.

The simple and effective coupling device as described above allows the user to set the image capturing device 90 in several different settings and angles, thereby permitting the user to effectively take photographs from a distance.

Referring again to FIG. 14, the lighting device 314 includes one or more light emitting elements 380. As described above, the lighting device 314 is mounted to the supporting device 310 and configured to provide one or more light sources when capturing photographs by the image capturing device 90 supported by the supporting device 310.

The light emitting elements 380 of the lighting device 314 are configured to produce a variety of artificial light ranging from soft light to hard light, and/or flash. Examples of the light emitting elements 380 include light emitting diodes, flash light, and/or incandescent light bulbs.

In some embodiments, the lighting device 314 has a power source (e.g., a battery unit) independent from other electronic-powered components, such as the image capturing device 90 and the control device 328. In other embodiments, the lighting device 314 is electrically connected to a power source (e.g., a battery unit) incorporated in the control device 328 at the rearward end 324 of the extension device 320. In this case, a plurality of wires can run from the lighting device 314 to the power source at the rearward end 324 through the first and second side members 334 and 336 and the extension device 320 to electrically connect the lighting device 314 to the power source.

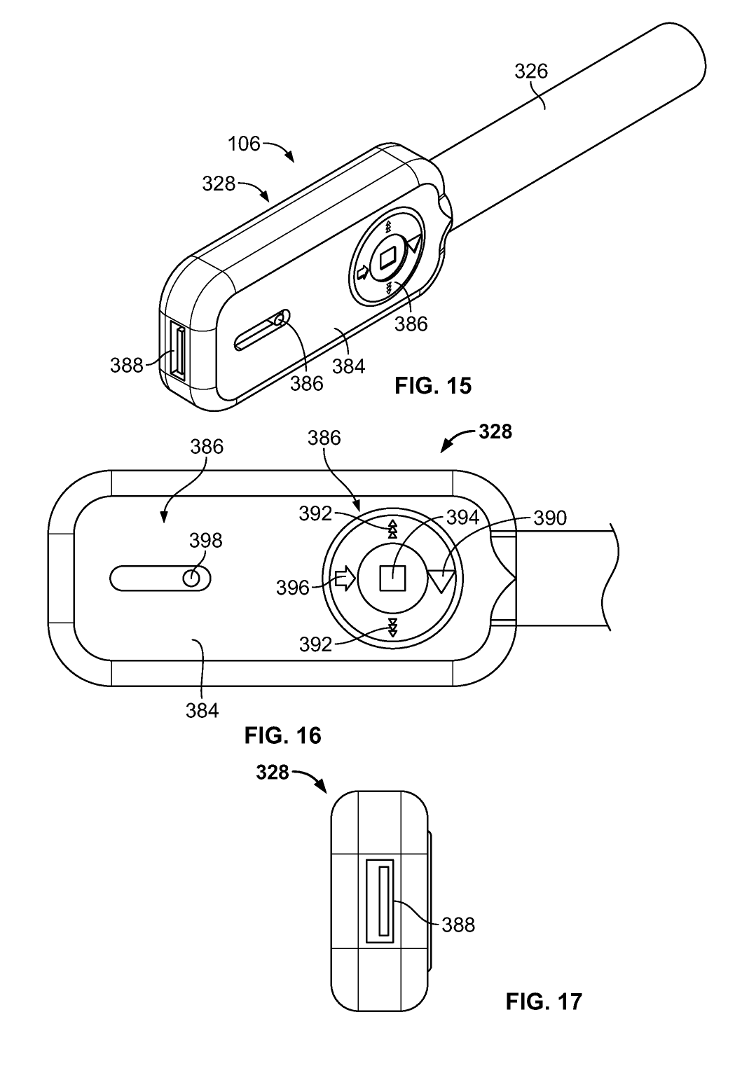

FIGS. 15-17 illustrate an example control device 328.

FIG. 15 is a perspective view of an example control device 328. In some embodiments, the control device 328 includes a main body 384, one or more input devices 386, and a USB port 388. Further, as shown in FIG. 3, the control device 328 includes a processing device 202, a wireless network interface 246, and a power supply 252.

The main body 384 is configured to house the components of the control device 328. In the depicted example, the main body 384 has a hollow rectangular housing with rounded corners and edges for user comfort. In some embodiments, the main body 384 is made of plastic, which is covered by a rubber-type material to facilitate easy and stable grip for the user.

The input devices 386 are arranged on one or more surfaces of the main body 384. The input devices 386 provides interface for user to interact with the image capturing device control engine 290, which includes the camera module control engine 292, the photograph management control engine 294, and the lighting device control engine 296, as illustrated in FIG. 6. As described above, the user can perform several functions of the image capturing device 90 and/or the lighting device 314 by manipulating the input devices 386.

The USB port 388 is arranged on the main body 384. In some embodiments, more than one USB ports are arranged on the main body 384. The USB port 388 is used to connect accessories and to recharge the power supply 252 of the control device 328.

As described in FIG. 3, the processing device 202 contains and executes instructions associated with the various functions of the control device 328. In some embodiments, the processing device 202 is a single integrated circuit on a silicon chip, also known as a microprocessor.

As described in FIG. 3, the wireless network interface 246 is employed to communicate with the image capturing device 90 and/or the lighting device 314 through the network 250. The wireless network interface 246 is a device including a plurality of transceiver microchips arranged and programmed in a specific manner which allows two devices to transfer data through wireless, radio waves based communication network. In some embodiments, the wireless network interface 246 is implemented with a Bluetooth card, which allows the control device 328 to pair with the image capturing device 90 and/or the lighting device 314 and relay user instructions via the network. For example, a Bluetooth 4.0 is used for optimum wireless data transfer capabilities with low power consumption and user friendly configuration.

As described in FIG. 3, the power supply 252 is used to supply electric power to the components of the control device 328. The power supply 252 is located within the main body 384, and connected to the USB port 388, the processing device 202, the wireless network interface 246, and other electronic devices or mechanisms. In some embodiments, the power supply 252 is also connected to the lighting device 314 with wiring. In some embodiments, the power supply 252 is one or more battery units. In some embodiments, a single lithium-ion rechargeable battery is used for the power supply 252. The rechargeable battery can be recharged through the USB port.

FIG. 16 is a top view of the control device 328 of FIG. 15, illustrating example input devices 386. In the depicted example, the input devices 386 include a playback button 390, a scroll button 392, a shutter button 394, a return button 396, and an ON/OFF button (not shown). The input devices 386 further includes a light adjustment actuator 398.

The playback button 390 is used to initiate playback of existing photographs stored in the image capturing device 90. In some embodiments, the photographs are displayed on the device 90 in sequence, each staying on the screen of the device 90 for an incremental amount of time.

The scroll button 392 is used to initiate a scroll function which allows the user to cycle through the photographs either forwards or backwards depending on the button pressed.

The shutter button 394 is used to initiate the camera module 92 to take a picture or video, depending on the previous settings.

The return button 396 is used to initiate a return-to-screen function, either returning to a photo-taking mode or to a predetermined application home page.

The light adjustment actuator 398 is used to adjust the amount of light provided by the image capturing device 90 and/or the lighting device 314. In the depicted example, the light adjustment actuator 398 is configured as a sliding knob to gradually change the amount of light between the lowest soft light (or no light) and the highest hard light.

In some embodiments, each or a combination of the buttons described above is used to perform different functions. One example of such functions is a Bluetooth pairing process, which needs to be done when the user first uses a control device 328 and an image capturing device 90 that have never been paired. The number of buttons, the type of buttons, button configurations, and their associated functions can be modified to meet the purpose of the control device 328.

FIG. 17 is a bottom view of the control device 328 of FIG. 15. In the depicted example, the control device 328 includes the USB port 388 on the side thereof.

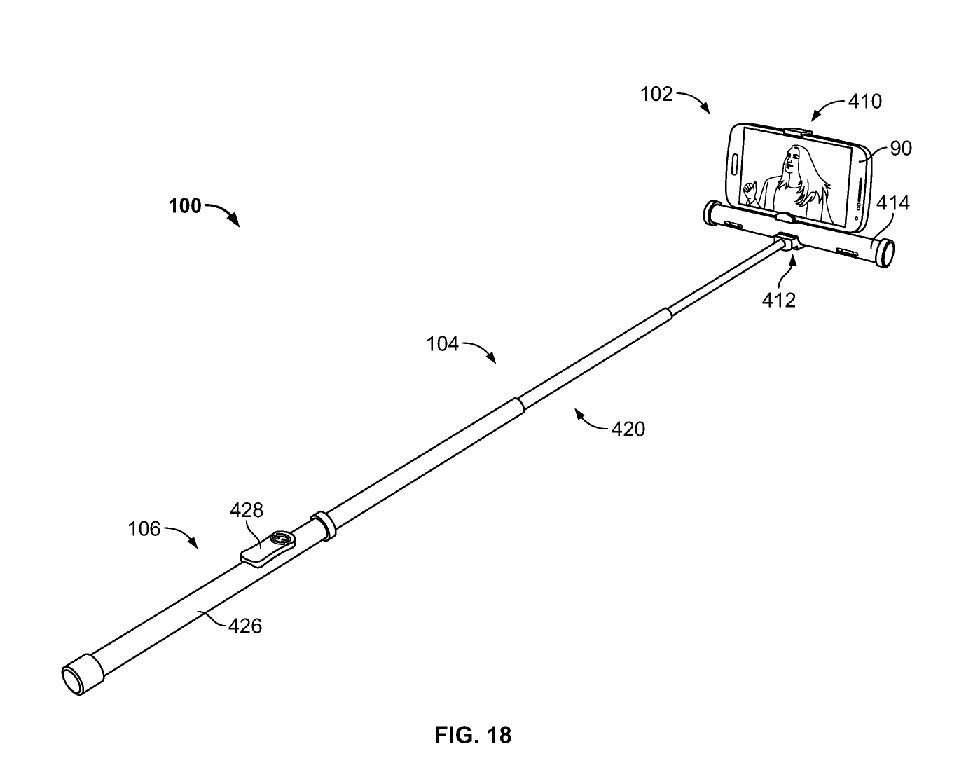

A second embodiment of the system 100 is described and illustrated with reference to FIGS. 18-24. As the concepts and features of the system 100, as described in FIGS. 1-17 are applied to the second embodiment, the description for the system 100 shown in FIGS. 1-17 is hereby incorporated by reference for the second embodiment. Where like or similar features or elements are shown, the same or similar reference numbers will be used where possible. The following description for the second embodiment will be limited primarily to the differences between the first and second embodiments.

FIG. 18 is a perspective view of an example system 100 for remotely controlling an image capturing device 90. As describe above, the system 100 includes the image capturing module 102, the extension module 104, and the handling module 106.

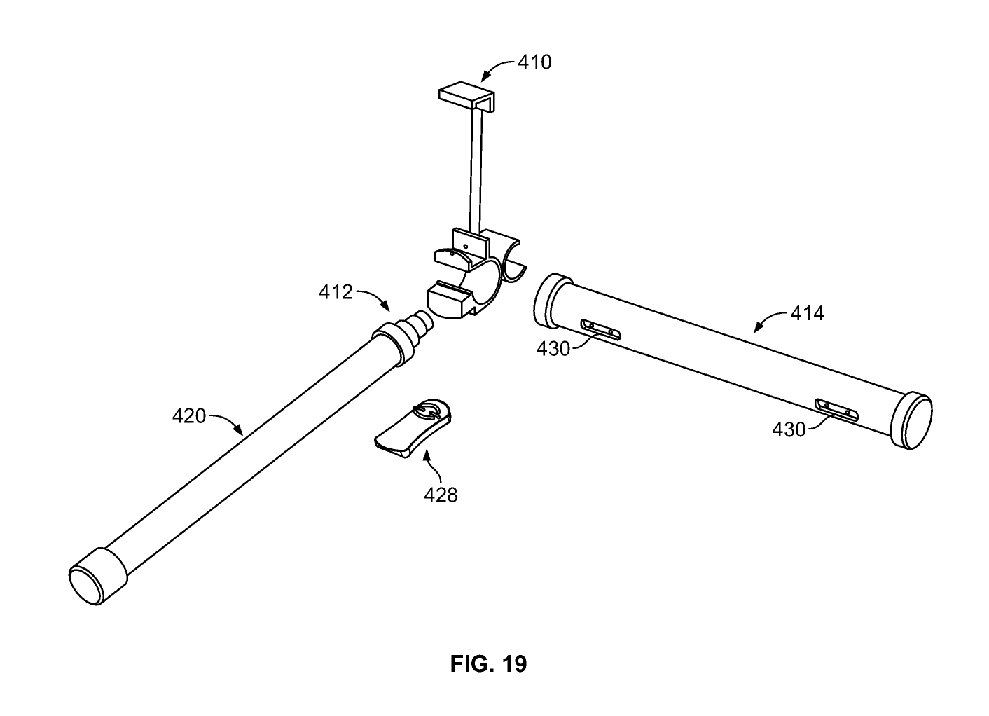

The image capturing module 102 includes a supporting device 410, a coupling device 412, and a lighting device 414. In some embodiments, the image capturing module 102 further include the mobile application 116 as illustrated above. Each component of the image capturing module 102 is described and illustrated with reference to FIG. 19.

The extension module 104 includes an extension device 420. An example of the extension device 420 is illustrated and described with reference to FIG. 19.

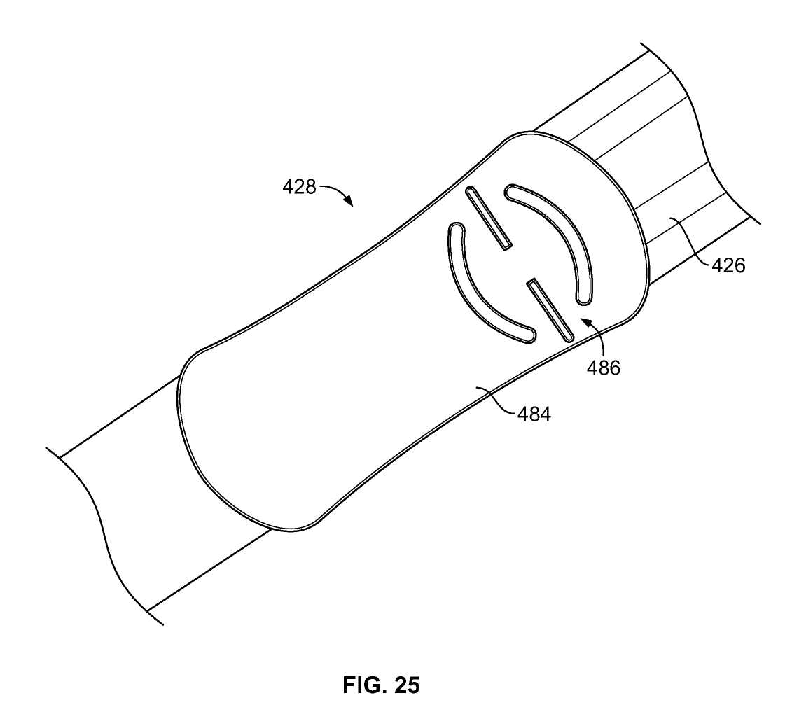

The handling module 106 includes a handling device 426 and a control device 428. The handling device 426 provides a grip for the user to hold the system 100. An example control device 428 is described and illustrated with reference to FIG. 25.

FIG. 19 is an expanded view of the system 100 of FIG. 18. As described above, the system 100 includes the supporting device 410, the coupling device 412, the lighting device 414, the extension device 420, and the control device 428.

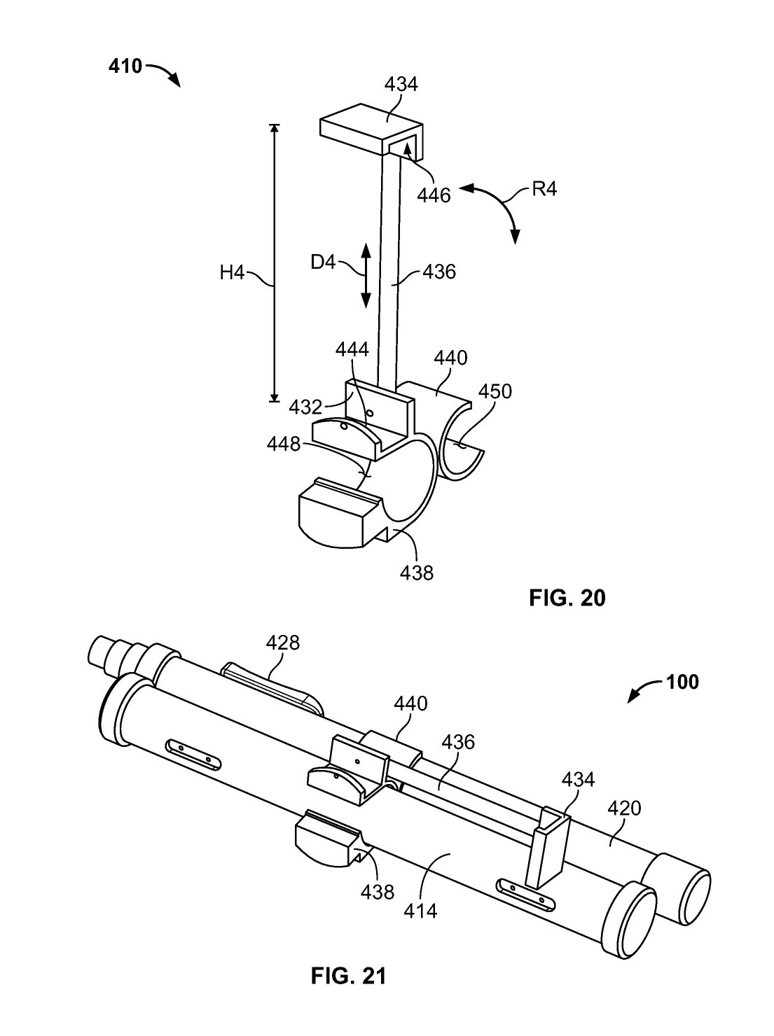

The supporting device 410 operates to hold the image capturing device 90 in place. An example of the supporting device 410 is described and illustrated with reference to FIG. 20.

The coupling device 412 operates to couple the supporting device 410 to the extension device 420. In some embodiments, the coupling device 412 detachably couples the supporting device 410 to the extension device 420. In some embodiments, the coupling device 412 pivotally couples the supporting device 410 to the extension device 420 so that the supporting device 410 freely rotates about the extension device 420 with three degrees of freedom (e.g., pitching, yawing, and rolling). In the depicted example, the coupling device 412 is configured as a ball joint type, as illustrated in the first embodiment. In other embodiments, the coupling device 412 is detachably coupled to a portion of the lighting device 414 that is secured to the supporting device 410 (e.g., a lighting device coupling portion 438 (FIG. 20)).

The lighting device 414 includes one or more light emitting elements 430. The features of the lighting device 314 and the light emitting elements 380 are similarly applicable to this embodiment.

The extension device 420 is the same as, or substantially similar to, the extension device 320 as described above.

The control device 428 is the same as, or substantially similar to, the control device 328 as described above. In this embodiment, the control device 428 can be detachably coupled to the handling device 426 or a portion of the extension device 420. An example of the control device 428 is described and illustrated with reference to FIG. 25.

FIG. 20 is a perspective view of an example supporting device 410. In some embodiments, the supporting device 410 includes a frame 432, a support member 434, and a support bar 436. The supporting device 410 further includes a lighting device coupling portion 438 and an extension device storage portion 440.

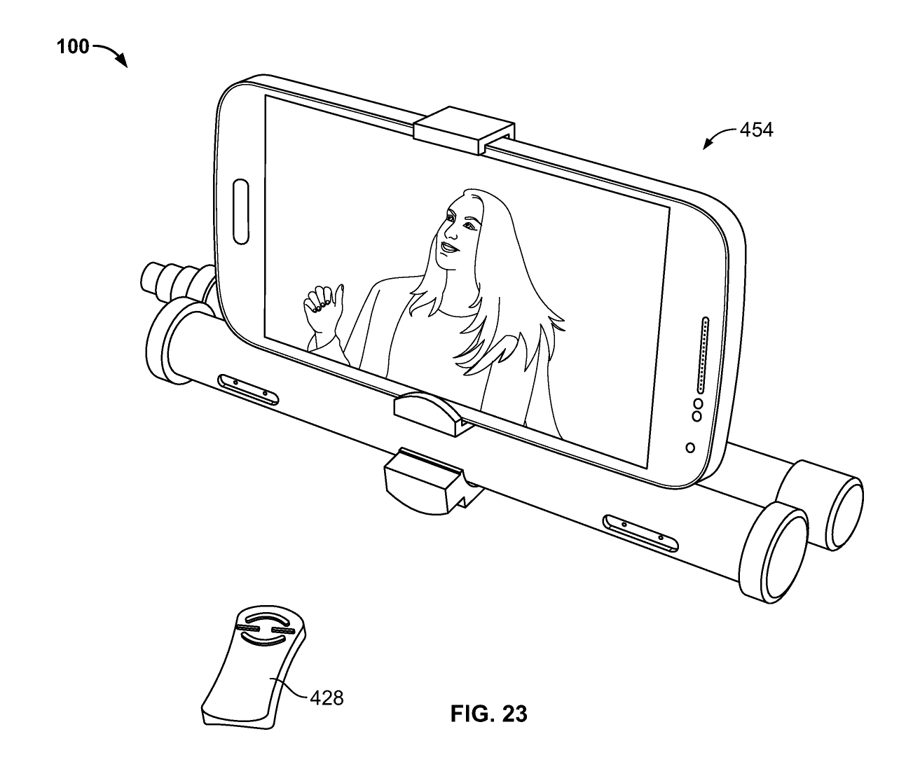

The frame 432 is configured to connect the support bar 436. Further, the frame 432 is constituted as part of the coupling device 412, and configured to engage the lighting device 414, as illustrated below. In some embodiments, the frame 432 includes a first groove or recess 444 configured to receive a first side portion of the image capturing device 90, as illustrated in FIG. 23.

The support member 434 is configured to receive a second side portion of the image capturing device 90, which is opposite to the first side portion of the image capturing device 90. As such, the image capturing device 90 is held by the cooperation of the frame 432 and the support member 434 at opposite sides of the image capturing device 90. In some embodiments, the support member 434 includes a second groove or recess 446 configured to receive the second side portion of the image capturing device 90, as illustrated in FIG. 23.

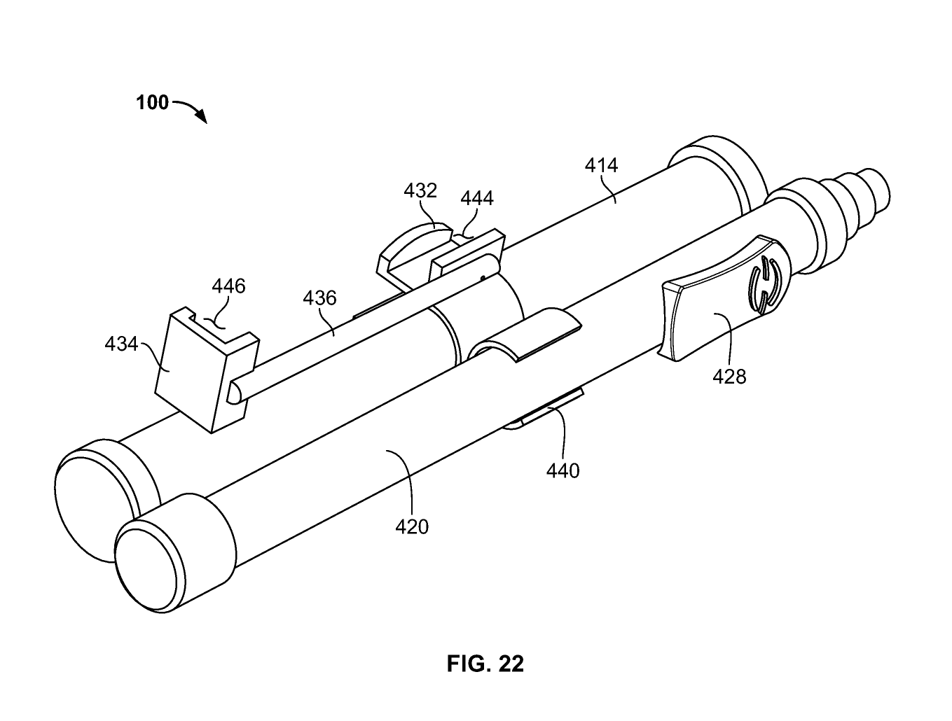

The support bar 436 extends between the frame 432 and the support member 434 and configured to support the rear face (i.e., the largest surface) of the image capturing device 90, as illustrated in FIG. 23. In some embodiments, the support bar 436 is fixed to the support member 434 at one end, and pivotally connected to the frame 432 at the other end. The support bar 436 can pivot about the frame 432 between an upright position (FIG. 19) and a lowered position (FIGS. 21 and 22) in a rotational direction (R4). In the upright position, the support bar 436 is substantially in a vertical position relative to the frame 432 so that the image capturing device 90 is engaged between the frame 432 and the support member 434. In the lowered position, the support bar 436 is substantially in a horizontal position so that the system 100 is ready for carrying or storage.

In some embodiments, the support bar 436 is configured to be adjustable in height (H4) in the direction (D4). The height (H4) of the support bar 436 is adjusted for different image capturing device 90 of different dimensions.

The lighting device coupling portion 438 is configured to engage the lighting device 414. In the depicted example, the lighting device coupling portion 438 includes a first snap-fit hole 448 to which the lighting device 414 is snap-fit, as illustrated in FIG. 21.

The extension device storage portion 440 is configured to engage the collapsed extension device 420. The extension device storage portion 440 is arranged at a lower part of the supporting device 410 so that the supporting device 410 is supported upright as a stand 454 (FIG. 23) for the image capturing device 90 when the collapsed extension device 420 is engaged with the extension device storage portion 440. In the depicted example, the extension device storage portion 440 includes a second snap-fit hole 450 to which the extension device 420 is snap-fit, as illustrated in FIG. 21. As depicted, the second snap-fit hole 450 is arranged at a lower part of the supporting device 410 and configured to be used as a base portion of the stand for the image capturing device 90.

FIGS. 21 and 22 illustrate that the system 100 is assembled in a storage condition. In particular, FIG. 21 is a front perspective view of the system 100 in the storage condition, and FIG. 22 is a rear perspective view of the system 100 in the storage condition. In the storage condition, the support bar 436 of the supporting device 410 is rotated to the lowered position. The lighting device 414 is inserted into the first snap-fit hole 448 to be engaged with the lighting device coupling portion 438. The extension device 420 is collapsed and inserted into the second snap-fit hole 450 to be engaged with the extension device storage portion 440. The lighting device 414 and the collapsed extension device 420 are both engaged with the supporting device 410 so that the lighting device 414 is arranged in parallel with the collapsed extension device 420. The control device 428 is attached to the handling device 426 or the collapsed extension device 420. As such, the system 100 is assembled to have a reduced volume when not in use, thereby helping the user carry and store the system 100 conveniently.

FIG. 23 is a perspective view of the system 100 used as a stand 454 for the image capturing device 90. When the system 100 is in the storage condition, the system 100 can be used as a stand 454 for supporting the image capturing device 90. To form the stand 454, the support bar 436 of the supporting device 410 is rotated back to the upright position. Then, the image capturing device 90 can be engaged to the supporting device 410. Because the lighting device 414 and the collapsed extension device 420 are engaged with the supporting device 410 and remain in parallel, they operate to support the supporting device 410 in a raised position against the ground. The user can detach the control device 428 from the handling device 426 or the collapsed extension device 420, and use is to control the image capturing device 90 at a remote distance.

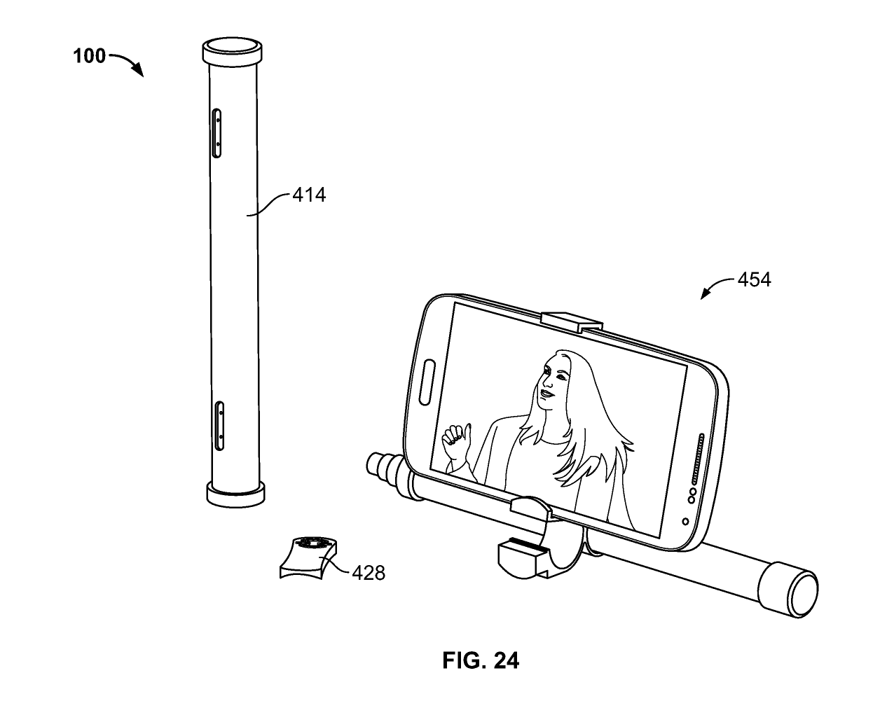

FIG. 24 is a perspective view of the system 100 used as a stand 454 with the lighting element used separately. While the system 100 is used the stand 454 as illustrated in FIG. 24, the lighting device 414 can be decoupled from the supporting device 410 and used apart from the supporting device 410 holding the image capturing device 90. Because of the configuration of the lighting device coupling portion 438, the extension device storage portion 440, and the extension device 420 engaged with the extension device storage portion 440, the supporting device 410 remains supported in the raised position against the ground. By locating the lighting device 414 appropriately and controlling it through the control device 428, the user can capture desired photographs via the image capturing device 90. For example, the stand-alone lighting device 414 can be used as a flashlight by manipulating the control device 428.

FIG. 25 is an example control device 428. Similarly to the control device 328, the control device 428 includes a main body 484 and one or more input devices 486. In some embodiments, the control device 428 is attached to the handling device 426 or a portion of the extension device 420 and detachable therefrom. The control device 428 is configured and operated the same as the control device 328.

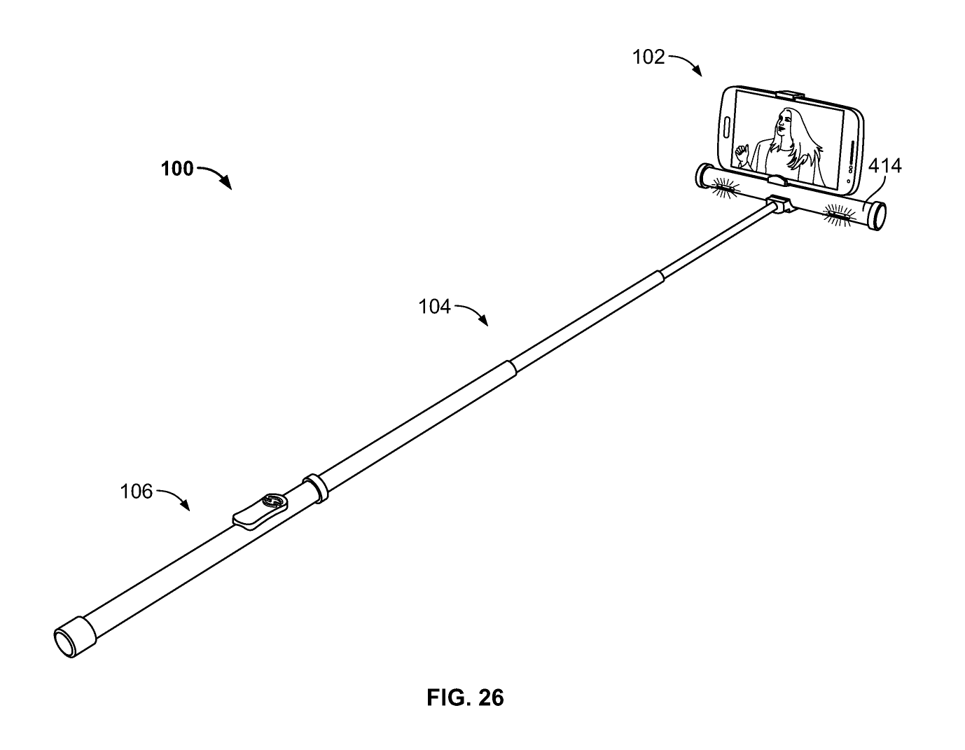

FIG. 26 is a perspective view of the system of FIG. 18, illustrating that the lighting device 414 is in operation. As described, the user can operate the control device 328 and turn on the light emitting elements of the lighting device 414 to illuminate the subject when the photograph is taken.

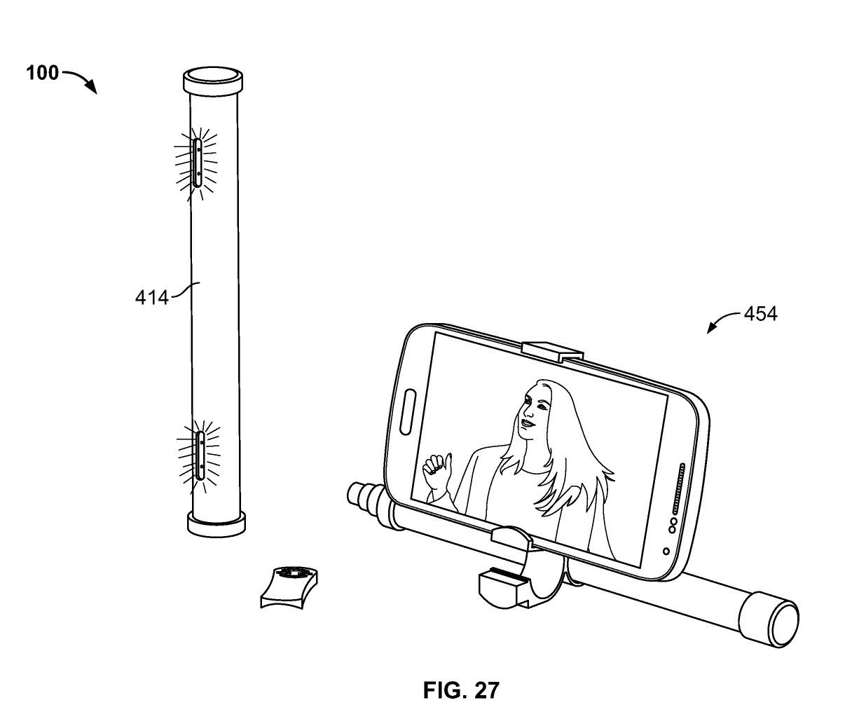

FIG. 27 is a perspective view of the system used as the stand 454, as shown in FIG. 24, illustrating that the lighting device 414 is in operation. As described, the user can operate the control device 328 and switch on the light emitting elements of the lighting device 414 when the system 100 is used as the stand 454 and the lighting device 414 is used as a stand-alone device.

FIG. 28 is a schematic diagram illustrating another example system 100 for remotely controlling the image capturing device 90 and/or a lighting device. As described above, the system 100 includes the image capturing module 102, the extension module 104, and the handling module 106.

The image capturing module 102 includes a supporting device 510, a coupling device 512, and a lighting device 514. In some embodiments, the image capturing module 102 further includes a mobile application 116. The extension module 104 includes an extension device 520. The handling module 106 includes a handling device 526 and a control device 528.

As the concepts and features of the system 100, as described in FIGS. 1-27, are applied to this example, the description for the system 100 shown in FIGS. 1-27 is hereby incorporated by reference for this example. Where like or similar features or elements are shown, the same or similar reference numbers will be used where possible, and the descriptions thereof are omitted for brevity purposes. The following description for this example will be focused primarily on possible differences from the previous embodiments.

In this example, the image capturing device 90 is at least partially covered by a case 500. The case 500 for the image capturing device 90 is configured to at least partially cover or wrap the image capturing device 90 for various purposes, such as protection of the image capturing device 90 or ornamental purposes. The case 500 can be made of various materials, such as plastic (either hard or flexible), rubber, leather, metal, or other materials or combinations of these or other materials. The case 500 can be of various types, such as frames, pouches, sleeves, holsters, shells, skins, bumpers, flip cases, wallets, screen protector, and other types suitable to at least partially cover the image capturing device 90.

In this example, the case 500 is configured to incorporate a lighting device 514 configured to provide one or more light sources to illuminate the subject when capturing a photograph by the image capturing device 90.

The case 500 is supported by the image capturing module 102 of the system 100. The image capturing module 102 as described in FIGS. 7-27 can be used to hold the case 500.

For example, the supporting device 510 can be configured similarly to the supporting device 110, 310, 410, as described in FIGS. 1-27.

Further, the coupling device 512 can be configured similarly to the coupling devices 112, 312, 412, as described in FIGS. 1-27 to couple the supporting device 510 and the extension module 104.

The lighting device 514 is configured similarly to the lighting device 114, 314, 414, as described in FIGS. 1-27, except that in some embodiments the lighting device 514 is part of the case 500. The one or more light sources of the lighting device 514 can be contained in, embedded in, or connected to the case 500, for example. In some embodiments, the case 500 includes a control interface for allowing the user to control the lighting device 514, and/or a power supply (e.g., a battery) for providing power to the lighting device 514 independently from a power supply of the image capturing device 90.

The extension device 520 can be configured similarly to the extension device 120, 320, 420, as described in FIGS. 1-27. The handling device 526 can be configured similarly to the handling device 126, 326, 426, as described in FIGS. 1-27. The control device 528 can be configured similarly to the control device 128, 328, 428 as described in FIG. 1-27. For example, the control device 128 is configured to control the lighting device 514 either directly or via the image capturing device 90 (e.g., using the camera module 92 and/or the photograph management application 94 that runs on the image capturing device 90), as described in FIGS. 1-27.

FIG. 29 is a schematic diagram illustrating yet another example system 100 for remotely controlling the image capturing device 90 and/or a lighting device. As describe above, the system 100 includes the image capturing module 102, the extension module 104, and the handling module 106.

As the concepts and features of the system 100, as described in FIG. 28, are applied to this example, the description for the system 100 shown in FIG. 28 is hereby incorporated by reference for this example. Where like or similar features or elements are shown, the same or similar reference numbers will be used where possible, and the descriptions thereof are omitted for brevity purposes. The following description for this example will be limited primarily to the differences from the previous embodiments

In this example, the image capturing module 102 is configured as a case 600 for at least partially covering the image capturing device 90. The case 600 is configured similarly to the case 500 as in FIG. 27, except that the case 600 is directly coupled to the extension module 104 via a coupling device 612.

Similarly to the case 500, the case 600 incorporates a lighting device 614. The lighting device 614 is configured similarly to the lighting device 514 as in FIG. 27.

The extension module 104 includes an extension device 620 that is configured similarly to the extension device 120, 320, 420, 520 as described in FIGS. 1-28.

The handling module 106 includes a handling device 626 and a control device 628. The handling device 626 can be configured similarly to the handling device 126, 326, 426, 526 as described in FIGS. 1-28. The control device 628 can be configured similarly to the control device 128, 328, 428, 528 as described in FIG. 1-27.

The coupling device 612 can be configured similarly to the coupling devices 112, 312, 412, 512 as described in FIGS. 1-28 to couple the case 600 and the extension module 104. Additional examples of the coupling device 612 are illustrated and described with reference to FIG. 30.

FIG. 30 schematically illustrates a part of an example coupling device 612 of FIG. 29 that is included in a structure of the case 600. In some embodiments, the coupling device 612 includes a base panel 632 and a fastening element 634.

The base panel 632 is configured to be part of a case body 630 and provides a base structure for fixing the fastening element 634 to the case body 630. For example, where the case body 630 is made with a flexible material, the base panel 632 provides a reinforcing structure for attaching the fastening element 634 to the case body 630 so that the extension module 104 robustly holds the case 600. In some embodiments, the base panel 632 can be embedded into a portion of the case body 630 as a separate element. In other embodiments, the base panel 632 can be attached an exterior surface, or an interior surface, of the case body 630. The base panel 632 can be made of various possible materials, such as plastic or metal.

The fastening element 634 is configured to secure the end of the extension module 104 (e.g., the extension device 620). The fastening element 634 can be configured to pivotally couple the extension module 104. In some embodiments, the fastening element 634 is configured as a flexible joint. In other embodiments, the fastening element 634 is configured similarly to the coupling device 312 as illustrated in FIG. 14, including a socket portion configured to pivotally receive a ball portion formed at a forward end of the extension module 104. In yet other embodiments, the fastening element 634 is configured as a screw socket for threaded coupling with a forward end of the extension module 104. In yet other embodiments, the fastening element 634 is configured as a clip for snap-fitting a forward end of the extension module 104.

In some embodiment the fastening element is connected to the base panel and extends through an opening in the case body.

In other embodiments, the base panel 632 and/or the fastening element 634 are configured to magnetically couple a forward end of the extension module 104.

Although it is illustrated in FIG. 30 that the coupling device 612 (including the base panel 632 and the fastening element 634) is provided on the back side of the case 600, the coupling device 612 is formed in any other portion of the case 600, such as a side or front of the case 600.

According to the foregoing description and associated Figures, some embodiments include one or more of the following, or any combination thereof:

A system for supporting an image capturing device, the system comprising: a supporting device configured to detachably support the image capturing device; an extension device connected to the supporting device and extendable to a desired length; a lighting device mounted to the supporting device and configured to provide one or more light sources when capturing a photograph by the image capturing device; and a control device configured to control the image capturing device via a data communication network.

The system, wherein the control device is configured to control the lighting device via the data communication network.

The system, wherein the data communication network is implemented with BLUETOOTH® wireless technology.

The system, further comprising a coupling device configured to pivotally couple the supporting device to the extension device.

The system, further comprising a coupling device configured to detachably couple the supporting device to the extension device.

The system, wherein the supporting device includes an extension device storage portion configured to engage the extension device when the extension device is collapsed.

The system, wherein the extension device storage portion is arranged at a lower part of the supporting device and configured as a base portion of a stand for the image capturing device when the collapsed extension device is engaged with the extension device storage portion.

The system, wherein the lighting device is detachably coupled to the supporting device.

The system, wherein the control device is detachably attached to the extension device.

The system, wherein the supporting device is configured to be adjusted to support different image capturing devices with different dimensions.

A method of capturing a photograph, the method comprising: mounting an image capturing device to a support device; attaching a lighting device to the support device; extending an extension device to a desired length, the extension device having forward and rearward ends and connected to the support device at the forward end; holding the rearward end of the extension device to capture a desired photograph; and interacting with a control device to transmit a user input to the image capturing device via a data transmission network, the user input configured to perform one or more functions of the image capturing device.

The method, further comprising: interacting with the control device to transmit a user input to the lighting device via the data transmission network, the user input configured to perform one or more functions of the lighting device.

The method, wherein the data communication network is implemented with BLUETOOTH® wireless technology.

The method further comprising: adjusting a position of the support device relative to the extension device, the support device pivotally coupled to the forward end of the extension device.

A hand-held apparatus for capturing a self-portrait photograph with a mobile device, the mobile device including a camera module, the apparatus comprising: a supporting device configured to detachably support the mobile device; a handling device configured for providing a grip; an extension device connecting the supporting device to the handling device, the extension device extendable to a desired length; a lighting device mounted to the supporting device and having one or more light emitting elements configured to produce artificial light when capturing the photograph; and a control device configured to remotely control the mobile device via a data communication network.

The apparatus, wherein the control device is configured to control the lighting device via the data communication network.

The apparatus, further comprising a coupling device configured to pivotally couple the supporting device to the extension device.

The apparatus, further comprising a coupling device configured to detachably couple the supporting device to the extension device.

The apparatus, wherein the lighting device is detachably coupled to the supporting device.

The apparatus, wherein the control device is detachably attached to the extension device.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A system for supporting an image capturing device, the system comprising:
a supporting device configured to detachably support the image capturing device;
an extension device connected to the supporting device and extendable to a desired length;
a lighting device mounted to the supporting device and configured to provide one or more light sources when capturing a photograph by the image capturing device; and
a control device configured to control the image capturing device via a data communication network.

2. The system of claim 1, wherein the control device is configured to control the lighting device via the data communication network.

3. The system of claim 1, wherein the data communication network is implemented with BLUETOOTH® wireless technology.

4. The system of claim 1, further comprising a coupling device configured to pivotally couple the supporting device to the extension device.

5. The system of claim 1, further comprising a coupling device configured to detachably couple the supporting device to the extension device.

6. The system of claim 5, wherein the supporting device includes an extension device storage portion configured to engage the extension device when the extension device is collapsed.

7. The system of claim 6, wherein the extension device storage portion is arranged at a lower part of the supporting device and configured as a base portion of a stand for the image capturing device when the collapsed extension device is engaged with the extension device storage portion.

8. The system of claim 1, wherein the lighting device is detachably coupled to the supporting device.

9. The system of claim 1, wherein the control device is detachably attached to the extension device.

10. The system of claim 1, wherein the supporting device is configured to be adjusted to support different image capturing devices with different dimensions.

11. A method of capturing a photograph, the method comprising:
mounting an image capturing device to a support device;
attaching a lighting device to the support device;
extending an extension device to a desired length, the extension device having forward and rearward ends and connected to the support device at the forward end;
holding the rearward end of the extension device to capture a desired photograph; and
interacting with a control device to transmit a user input to the image capturing device via a data transmission network, the user input configured to perform one or more functions of the image capturing device.

12. The method of claim 11, further comprising:
interacting with the control device to transmit a user input to the lighting device via the data transmission network, the user input configured to perform one or more functions of the lighting device.

13. The method of claim 11, wherein the data communication network is implemented with BLUETOOTH® wireless technology.

14. The method of claim 11, further comprising:
adjusting a position of the support device relative to the extension device, the support device pivotally coupled to the forward end of the extension device.

15. The system of claim 1, wherein the image capturing device is a mobile device including a camera module.

16. The apparatus of claim 15, wherein the control device is configured to control the lighting device via the data communication network.

17-20. (canceled)

21. A system for supporting an image capturing device, the system comprising:
a case for at least partially covering the image capturing device, the case including a lighting device configured to provide one or more light sources when capturing a photograph by the image capturing device;
an extension device extendable to a desired length;
a coupling device configured to connect the extension device to the case; and
a control device configured to control the lighting device.

22. The system of claim 21, wherein the case comprises:
a body;
and
a fastening element connected to the body, wherein the fastening element is configured for attachment to an extension handle.

23. The system of claim 22, wherein the case further comprises a base panel coupled to the body and to the fastening element, wherein the fastening element extends through an opening in the body.

24. The system of claim 22, further comprising a wireless communication device, wherein the wireless communication device receives signals from a remote control operable by a user to adjust an on-off state of the light sources.
